(19) United States
(12) Patent Application Publication
(10) Pub. No.: US 2023/0063345 A1
(43) Pub. Date: Mar. 2, 2023

(54) OPERATING A TERMINAL DEVICE AND A NETWORK NODE IN A WIRELESS MIMO SYSTEM

(71) Applicant: Sony Group Corporation, Tokyo (JP)

(72) Inventors: Olof ZANDER, Sodra Sandby (SE); Erik BENGTSSON, Eslov (SE); Fredrik RUSEK, Eslov (SE); Kun ZHAO, Malmo (SE); Jose FLORDELIS, Lund (SE)

(21) Appl. No.: 17/793,222

(22) PCT Filed: Jan. 25, 2021
(86) PCT No.: PCT/EP2021/051550

§ 371 Date: Jul. 15, 2022

(30) Foreign Application Priority Data
Jan. 31, 2020 (SE) 2030029-9

(51) Int. Cl. H04B 7/06; H04B 7/0413

(52) U.S. Cl. CPC H04B 7/0639; H04B 7/0413

(57) ABSTRACT

The present application relates to a method for operating a device (30) of a wireless multiple-input and multiple-output, MEM, system (10) providing a wireless communication between the device (30) and a network node (20) of the MIMO system (10). The method comprises: transmitting (102), from each individual antenna element (32) of a plurality of antenna elements of the device (30), a respective raw pilot signal in orthogonal resources to the network node (20); transmitting (105) a message indicative of a covariance matrix of interference to the network node (20), wherein the covariance matrix of interference is based on an interfering signal interfering the wireless communication; determining (106) an equalizer configuration to be used for receiving communication signals from the network node (20), wherein the equalizer configuration is based on the covariance matrix of interference; receiving (107), from the network node (20), a message indicative of a transmit precoding information, the transmit precoding information being determined by the network node (20) based on the raw pilot signals; and determining (108) a transmit precoding to be used by the device (30) for transmitting communication signals to the network node (20), wherein the transmit precoding is based on the transmit precoding information.

### FIELD OF THE INVENTION

Various examples relate to methods for operating devices in a wireless multiple-input and multiple-output (MIMO) system providing a wireless communication. In particular, various examples relate to methods for operating a terminal device and correspondingly cooperating methods for a network node for determining transmit precodings and equalizer configurations to be used for communicating signals between the terminal device and the network node. The present invention relates furthermore to devices implementing the methods.

### BACKGROUND OF THE INVENTION

For meeting the increasing demands in data and voice communication in daily life including personal communication via mobile telephones, smart phones and machine type communication (MTC), for example communication of Internet of things (IOT), the so-called multiple-input and multiple-output (MIMO) technology may be used in wireless communication systems, for example wireless cellular telecommunication systems. MIMO technology may also be referred to as multi-antenna technology.

In MIMO systems multiple send and receive antennas may be utilised at a network node, for example a base station or an access point, as well as at terminal devices for the wireless communication. The MIMO technology utilises coding techniques, which use the temporal and the spatial dimension for transmitting information. This enhanced coding of MIMO systems allows to increase the spectral and energy efficiency of the wireless communication.

According to MIMO technologies, the network node may include a large number of antennas that are operated fully coherently and adaptively. The network node may include for example several tens or even in excess of one hundred antennas with associated transceiver circuitry. Systems using a very large number of antennas, for example hundreds or thousands of antennas, are also referred to as massive MIMO systems. The extra antennas of a MIMO network node allow radio energy to be spatially focused in transmissions as well as a directional sensitive reception, which improve spectral efficiency and radiated energy efficiency. In a MIMO system, multiple signals from different radiation paths may be used and may be coherently combined such that a higher gain may be achieved, the so-called (massive) MIMO gain.

In the same way as the network node, the terminal devices may each include a plurality of antennas to allow radio energy to be spatially focused in transmissions as well as a directionally sensitive reception, which improves spectral efficiency and radiated energy efficiency.

In order to adapt transmit and receive signals at each individual antenna of the network node in accordance with the currently active terminal device, a network node logic needs information about wireless radio channel properties between the terminal device and the antennas of the network node. A channel sounding procedure, also known as pilot signalling scheme, may be used for this purpose. Based on a transmission of training sequences, which are also known as pilot signals, reference signals or sounding reference signals (SRS), the channel sounding procedure allows the network node to set antenna configuration parameters for transmitting signals, so as to focus radio energy at the terminal device and/or for directing the receive sensitivity for receiving radio signals from the terminal device. Thus, focus may mean both phase align contribution with different path lengths and transmit mainly in directions that will reach the terminal device. The pilot signals may be transmitted from the terminal device in a resource that is dedicated to the terminal device. Training sequences from different terminal devices can be orthogonal in order for the network node to identify the configuration parameters for the plurality of antennas for each one of the terminal devices. Orthogonality may be achieved by using time division multiple access (TDMA), code division multiple access (CDMA) or frequency division multiple access (FDMA) technologies or a combination thereof.

In case the MIMO system uses time division multiple access (TDMA) or frequency division multiple access (FDMA), each terminal device can transmit a pilot signal in a specifically allocated resource (defined for example by its time slot and frequency range within a frame, i.e. a time-frequency radio resource). For example, systems according to LTE (Long Term Evolution) technologies and standards support both frequency division duplex (FDD) and time division duplex (TDD) modes. While FDD makes use of paired spectra for uplink (UL) and downlink (DL) transmissions separated by a duplex frequency gap, TDD splits one frequency carrier into alternating time periods for transmission from the network node to the terminal device and vice versa. Both modes have their own frame structures within LTE and these are aligned with each other meaning that similar hardware can be used in the network nodes and terminal devices to allow for economy of scale. The LTE transmission is structured in the time domain in radio frames. Each of these radio frames is 10 ms long and consists of 10 sub-frames of 1 ms each. The Orthogonal Frequency Division Multiple Access (OFDMA) sub-carrier spacing in the frequency domain is 15 kHz. Twelve of these sub-carriers together allocated during a 0.5 ms timeslot are called a resource block. Each resource block may contain a plurality of resource elements. An LTE terminal device can be allocated, in the downlink or uplink, a minimum of two resource blocks during one sub-frame (1 ms). A resource block, defined by its time slot and set of sub-carriers, is the smallest unit of resources that can be allocated to a terminal device or user. Such a resource block may be called time-frequency radio resource. Data transmitted via resource blocks in a plurality of consecutive frames is also called “stream”. Orthogonality for pilot signals may be achieved by allocating different resources.

An uplink pilot signal can be received by the antennas of the network node and analyzed by the network node, e.g., by specific logic for channel sounding the uplink radio channel. Vice versa, the network node may transmit a downlink pilot signal in an allocated resource to a terminal device for channel sounding the downlink radio channel. The timeslots and frequency ranges in which terminal devices may transmit their pilot signals are sometimes referred to as pilot portion of a transmission frame. The remaining timeslots and frequency ranges of the frame may be used for downlink (DL) and uplink (UL) data and control transmission. The pilot signals received at the plurality of antennas of the network node are analyzed, e.g., by the respective network node logic. Information about a radio channel property of the radio channel between the terminal device and the plurality of antennas of the network node may be obtained as a result of this analysis. A network node may use the results of the analysis to determine configuration parameters for transmitting signals via the antennas to the respective terminal devices and for receiving signals via the antennas from the respective terminal devices. For example, based on the received uplink pilot signal, receive configuration parameters may be obtained and transmit configuration parameters may be obtained based on reciprocity. Thus, downlink pilot signalling may be avoided. Receive configuration parameters are also known as equalizer configuration, and transmit configuration parameters are also known as transmit precoding.

As the wireless radio channel property of the radio channel between the terminal device and the network node may vary with time, the pilot signalling is typically repeated after at least a so-called coherence time, which indicates the time duration over which the channel property is considered or assumed to be not varying. Likewise, as the transmission of payload data may use large frequency ranges, for each coherence bandwidth of a payload data transmission a corresponding pilot signal may be provided for analyzing the channel properties within the coherence bandwidth. The coherence bandwidth is a statistical measurement of a range of frequencies over which the channel is considered to be “flat”, or in other words the approximate maximum bandwidth over which two frequencies of a signal are likely to experience comparable or correlated amplitude fading.

To sum up, (massive) MIMO may be advantageous in terms of spectral efficiency. It enables multiple users to simultaneously use the same time and frequency resources. However, performance may be limited by a coherence block size (this is the combination of coherence time and coherence bandwidth) as each coherence block needs a pilot signal for each stream. The pilot signals are scarce resources as they need to be orthogonal in time and/or frequency and/or coding (CDMA) domain and hence become overhead that may limit the spectral efficiency.

For saving resources required for the transmission of pilot signals, the terminal device may transmit pilot signals using the plurality of antennas and the above described transmit configuration parameters within the coherence block size such that a same resource may be used by a plurality of terminal devices. In other words, the pilot signals are transmitted using a transmit precoding. Thus, the network node can distinguish the pilot signals received from different terminal devices and may adapt its receive configuration parameters for each terminal device based on the received pilot signals. Based on the receive configuration parameters, the network node may obtain or adapt corresponding transmit configuration parameters based on reciprocity (i.e., assuming that the transmission in one direction using certain transmit precoding shows similar radio channel properties as a further transmission in the other direction using an equalizer configuration that corresponds to the transmit precoding, e.g., uses similar or scaled amplitudes and phases for the antenna elements). Furthermore, instead of transmitting a pilot signal from the network node to the terminal device, the network node may transmit payload data using the plurality of antennas and the above described transmit configuration parameters and the receiving terminal device may adapt its receive configuration parameters by optimising gain and signal-to-noise ratio. Based on the thus determined receive configuration parameters, the terminal device may obtain or adapt its corresponding transmit configuration parameters based on reciprocity.

It has been found that the assumption of reciprocity is not always accurate. Then, the reliability of MIMO transmission can suffer.

### SUMMARY OF THE INVENTION

In view of the above, there is a need in the art for enhancing MIMO transmission.

According to the present invention, this object is achieved by the features of the independent claims. The dependent claims define embodiments of the invention.

Various examples described herein are based on the following finding: a condition that may violate the assumption of reciprocity is when there is interference present in the radio channel which may interfere essentially only one direction, for example only the receive direction at the terminal device. The techniques described herein facilitate a reliable MIMO transmission even in the presence of channel interference.

In the following description, the term “resource” will be used. In particular in TDD and FDD technologies, a resource may represent a “time-frequency radio resource”. With regard to LTE technologies, a time-frequency radio resource may relate to at least one resource block and is therefore characterised by time slot(s) and the frequency range(s) of its subcarriers. In particular, with regard to LTE technologies and according to the present invention, a time-frequency radio resource may relate to a plurality of resource blocks within a predetermined coherence bandwidth and/or coherence time. For example, the plurality of resource blocks may comprise the resource blocks within a frame or some subsequent frames and within a predetermined frequency range (for example within a coherence bandwidth within the range of 1 to 5 MHz).

Furthermore, in the following description the terms “transmit precoding” and “equalizer configuration” will be used. The transmit precoding may comprise a definition of a phase and gain or amplitude for each antenna element of a plurality of antenna elements of a communication device, for example a terminal device or a network node. The phase and gain or amplitude are used when transmitting a radio communication signal, for example a radio payload signal, a radio control signal or a radio pilot signal, via the corresponding antenna element. Consequently, a radio signal transmitted using the phase and gain or amplitude will be designated as “precoded signal”. In the art, such a precoded signal is sometimes also designated as beamformed signal. The equalizer configuration may comprise a definition of a phase and gain or weighting for each antenna element of the plurality of antenna elements of the communication device, for example a terminal device or a network node. The phase and gain or weighting is used when receiving a radio communication signal, for example a radio payload signal, a radio control signal or a radio pilot signal, via the corresponding antenna element. In the art, an equalizer configuration is also known as “receive precoding” and may be considered as a filtering of the radio communication signals received via the plurality of antenna elements.

According to various examples, a MIMO communication system comprising a first node and a second node are provided. A transmit precoding to be used by the first node for transmitting from the first node to the second node is not (e.g., fully) determined or generated by the first node itself, but determined or generated at least partly by the second node and signaled to the first node. For example, respective transmit precoding information encoding data that can be used to determine or generate the transmit precoding may be signaled to the first node. Alternatively or additionally, it would be possible that the receive equalizer to be used by the first node for receiving from the second node is not (e.g., fully) determined or generated by the first node itself, but determined or generated by the second node and then signaled to the first node. For example, respective receive equalizing information encoding data that can be used to determine the receive equalizer may be signaled to the first node.

Such transmit precoding information and/or receive equalizer information may directly and explicitly indicate the transmit precoding and/or receive equalizing, or may be implicitly indicative of the transmit precoding and/or receive equalizing so that some additional logic to derive the transmit precoding and/or receive equalizing is used.

For example, the first node may be implemented by a terminal device and the second node may be implemented by a network node; other scenarios are conceivable, e.g., for sidelink communication, peer-to-peer communication, etc.

To achieve this, it is possible to communicate certain radio channel properties as seen by the first node to the second node. The communication can be explicit or implicit. For example, a measure of the interference and the channel may be communicated to the second node. This may include transmitting and receiving uplink pilot signals, e.g., raw uplink pilot signals. Also, an explicit or implicit or compressed indication of respective matrices defined in the space of the MIMO channels can be transmitted.

Thus, to some extent, the MIMO operation of the first node can be said to be remote controlled by the second node.

According to the present invention, a method for operating a device of a wireless multiple-input and multiple-output (MIMO) system is provided. The device may comprise for example a terminal device like a mobile telephone, in particular a so-called smart phone, a tablet PC or an Internet of Things (IoT) device. However, the method is not restricted to terminal devices, but may also be used in connection with a base station, relay device or access device of the MIMO system. The wireless MIMO system may comprise for example a cellular Long Term Evolution (LTE) system or 5G New Radio (NR) as defined by 3GPP. The MIMO system provides a wireless communication between the device and a network node of the MIMO system. The network node may comprise for example a base station or access device of the MIMO system, for example an eNB in LTE systems or an gNB in 5G NR systems.

According to the method, from each individual antenna element of a plurality of antenna elements of the device a respective raw pilot signal is transmitted in orthogonal resources to the network node. The plurality of antenna elements is also known as antenna array. This means that from each antenna element a raw pilot signal is transmitted. The raw pilot signals may be transmitted from the antenna elements sequentially one after the other, i.e. first, a raw pilot signal is transmitted from a first antenna element while the remaining antenna elements of the plurality of antenna elements are silent, and then a raw pilot signal is transmitted from a second antenna element while the remaining antenna elements of the plurality of antenna elements are silent, and then a raw pilot signal is transmitted from a third antenna element while the remaining antenna elements of the plurality of antenna elements are silent, and so on. This is continued until a raw pilot signal is sent from the last antenna element of the plurality of antenna elements while the remaining antenna elements of the plurality of antenna elements are silent. The raw pilot signals may be transmitted simultaneously from the antenna elements, i.e. a raw pilot signal is transmitted from a first antenna element simultaneously with a transmission of a raw pilot signal from a second antenna element simultaneously with a transmission of a raw pilot signal from a third antenna element and so on. The raw pilot signals may also be transmitted partially simultaneously and partially sequentially.

As a general rule, a “raw” pilot signal can be a pilot signal which is transmitted without precoding, i.e., a pilot signal which is transmitted from one antenna element without a specific phase with respect to pilot signals transmitted from the other antenna elements. As a further general rule, the phase with which the raw pilot signal is transmitted by the originator node (e.g., the device) may be known to the receiving node (e.g., the network node). For example, the raw pilot signal may have a specific phase with respect to a timing scheme shared by the device and the network node. Based on the timing scheme, the network node may determine a delay or phase offset induced by the transmission via the radio channel between the device and the network node. The amplitude of the “raw” pilot signal may be known to the network node, or at least a relationship between amplitudes transmitted from different antenna elements of the terminal device may be known to the network node. In particular, a same amplitude may be used when transmitting raw pilot signals from different antenna elements of the terminal device.

The raw pilot signals may be configured such that the network node can estimate the downlink channel matrix based on the received raw pilot signals. In contrast, “precoded pilot signals” may encode information on the downlink precoding, and may therefore not be used to estimate the downlink channel matrix.

For achieving orthogonally, each raw pilot signal may be transmitted in a respective dedicated time-frequency resource.

Furthermore, according to the method, a message indicative of a covariance matrix of interference is transmitted to the network node. The covariance matrix of interference is based on an interfering signal interfering the wireless communication. For example, the device may receive the interfering signal at the plurality of antennas of the device and may analyze received interfering signal for determining the covariance matrix of interference. For example, the interfering signal may come from an interferer, for example another terminal device, access point, relay station or base station operated in the MIMO system or operated in another wireless communication system, or the interfering signal may come from any other interferer emitting a radio signal in at least parts of the frequency range used for the wireless communication in the MIMO system. The interfering signal may interfere the communication between the network node and the device in a receive direction of the device. An equalizer configuration to be used by the device for receiving communication signals from the network node is determined. The equalizer configuration is determined based on the covariance matrix of interference. For example, based on the covariance matrix of interference, the device may compute an equalizer configuration which attenuates or nulls the interfering signal. The device may receive radio communication signals from the network node using the equalizer configuration such that interference from the interfering signal may be reduced when receiving the radio communication signals from the network node.

Further, according to the method, a message indicative of a transmit precoding information is received from the network node. The transmit precoding information is determined by the network node based on the raw pilot signals from the device. Based on the transmit precoding information, the device determines a transmit precoding to be used by the device for transmitting communication signals to the network node. The transmit precoding may be used for transmitting payload and/or control information from the device to the network node. The transmit precoding may be used for all further payload and control transmissions from the device to the network node until a new or updated transmit precoding is determined. The transmit precoding may be updated in regular terms or upon request from the network node, for example upon detecting a signal degradation.

The method may comprise detecting the interfering signal, which interferes the wireless communication, and determining the covariance matrix of interference based on the interfering signal. For example, the interference may be considered as a colored thermal noise. A noise-plus-interference profile may be determined for the multi-antenna device and the covariance matrix of interference may be determined based on a noise-plus-interference profile and the thermal noise. Considering the covariance matrix of interference when determining the equalizer configuration may reduce interference in the receive direction of the device and may thus improve reception.

The transmit precoding information may be indicative of a Gram matrix. The transmit precoding information can include encoded data that can be decoded to obtain the indicator indicative of the Gram matrix. For instance, a multi-bit codeword may be used to encode such indicator. The Gram matrix may be determined at the network node based on the raw pilot signals received at the network node. As a general rule, the Gram matrix indicates an inner product of a channel matrix, which indicates channel conditions of a wireless communication channel between the device and the network node, and the Hermitian conjugate of the channel matrix. The channel conditions of the wireless communication channel between the device and the network node may be determined based on the received raw pilot signals. For example, the network node may compute a Hermitian conjugate based on receive properties (amplitude and phase) of the raw pilot signals received at the plurality of antenna elements of the network node. The transmit precoding to be used by the device is determined based on the Gram matrix. In particular, the Gram matrix and consequently the transmit precoding may be determined based on the raw the pilot signals, but may be determined independent of the interfering signal, for example independent of the covariance matrix of interference. Thus, the transmit precoding used by the device for transmitting communication signals from the device to the network node may have a different characteristic than the equalizer configuration, i.e. the transmit precoding and the equalizer configuration may not be reciprocal. Therefore, advantageously, in the received direction, the equalizer configuration considers the interfering signal, whereas in the transmit direction, which may not be affected by the interfering signal, the transmit precoding only considers the channel conditions.

The equalizer configuration may be determined based on considering the covariance matrix of interference and additionally the Gram matrix.

An update of the transmit precoding and/or the equalizer configuration may be required from time to time or under certain conditions. For example, a time interval between the transmission of the raw pilot signals from each individual antenna element and the further transmission of raw the pilot from each individual antenna element may be smaller than a time interval between the transmission of the message indicative of the covariance matrix of interference and a further transmission of a further message indicative of a further covariance matrix of interference. In other words, the raw pilot signals may be transmitted more frequently than the covariance matrix of interference. Consequently, the transmit precoding may be updated more frequently than the equalizer configuration. For example, the covariance matrix of interference may be transmitted only once per 5 to 10 transmissions of the raw pilot signals from each individual antenna element. Intervals for adjusting or updating the transmit precoding and/or the equalizer configuration may be short, for example in a range of 0.5 to 10 ms, in particular for example 1 ms. Thus, coherency and a corresponding MIMO gain may be maintained for each communication channel between the network node and device.

In further embodiments, a further message indicative of a further covariance matrix of interference is transmitted upon detecting a change in the interfering signal. Thus, the covariance matrix of interference may be transmitted to the network node only when the interfering signal changes.

According to further embodiments, the device may receive, from the network node, a request for transmitting a further covariance matrix of interference. Upon receiving the request, the device detects the interfering signal, which interferes the wireless communication, and determines a further covariance matrix of interference based on the interfering signal. The further covariance matrix of interference is transmitted to the network node in a further message.

In further embodiments, the covariance matrix of interference may be updated and transmitted to the network node in regular terms, for example upon expiry of a timer, for example in regular intervals in a range of 100 ms to 2 seconds.

For determining the transmit precoding information in the network node, the network node may consider properties of the transmit capabilities of the device. For example, a message indicative of a transmitter configuration of the device may be transmitted to the network node. The transmitter configuration of the device may comprise information concerning a number of available transmitters or transmitter chains, i.e. the number of transmitters which may be used simultaneously. Each transmitter may be assigned to a specific antenna element or each transmitter may be dynamically assignable to a specific antenna element such that, in case the number of transmitters is lower than the number of antenna elements, the antenna elements may be provided with communication signals in a time multiplexed manner.

In various examples, the raw pilot signals are transmitted simultaneously via the plurality of antenna elements. This may enable the network node to determine and consider a phase relationship between the received raw pilot signals for analyzing the characteristics of the wireless communication channel between the device and the network node.

For transmitting the raw pilot signals simultaneously, the device may comprise for each antenna element of the plurality of antenna elements a respective radio transmitter. The radio transmitter, which is also known as transmit radio chain, may comprise for example a power amplifier configured to amplify a single communication signal.

In other examples, the raw pilot signals are transmitted sequentially one after the other via the plurality of antenna elements. In this case, the raw pilot signals may be transmitted according to a predefined timing scheme such that the network node may determine and consider a phase relationship between the raw pilot signals although they were not transmitted simultaneously.

In case the raw pilot signals are transmitted sequentially, for example one after the other, the device may comprise a lower number of radio transmitters than the number of antenna elements of the plurality of antenna elements. The device may comprise a switching element configured to selectively couple at least one of the radio transmitters with either a first antenna element of the plurality of antenna elements or a second antenna element of the plurality of antenna elements. For example, the device may comprise only a single radio transmitter and a switching element which is configured to selectively couple the single radio transmitter selectively with any one of the plurality of antenna elements.

Furthermore, some of the raw pilot signals may be transmitted simultaneously and some may be transmitted sequentially via the plurality of antenna elements. For example, in case of four antenna elements, first, a raw pilot signal may be transmitted from a first antenna element and simultaneously a raw pilot signal may be transmitted from a second antenna element, and after that, a raw pilot signal may be transmitted from a third antenna element and simultaneously a raw pilot signal may be transmitted from a forth antenna element. In this case, the device may comprise two radio transmitters which may be selectively connected with either the first and second antenna element or with the third and fourth antenna elements.

To sum up, the “the optimal” transmit precoding for the device may not be derived by the device itself, but may be derived at the network node and communicated to the device. It is to be noticed that it is also possible for the network node to determine the equalizer configuration of the device, and then communicate such configuration to the device. For example, once the covariance matrix of interference and the channel matrix are derived and the configuration of the device is known to the network node, it can determine transmit precoding and/or equalizer configuration for uplink and/or downlink). Thus, the network may determine configurations and the devices need not be smart.

However, even when some determinations are made at the device (e.g., the device determines the uplink precoding, or the downlink equalizer to be used by itself) it is to be understood that this determinations match to corresponding determinations at the network node (e.g., the uplink equalizer, or downlink precoder). There is thus an agreement as to which transmission mode is to be used, in the downlink and the uplink, jointly by the network node and the device.

According to various examples, a device of a wireless multiple-input and multiple-output, MIMO, system is provided. The MIMO system provide a wireless communication between the device and a network node of the MIMO system. The device comprises control circuitry. The control circuitry may comprise for example a control logic or a processor and a control program. The control circuitry is configured to transmit, from each individual antenna element of a plurality of antenna elements of the device, a respective raw pilot signal in orthogonal resources. The control circuitry is further configured to transmit a message indicative of a covariance matrix of interference to the network node. The covariance matrix of interference is based on an interfering signal interfering the wireless communication in a receive direction of the device. The control circuitry is configured to determine an equalizer configuration to be used by the device for receiving communication signals from the network node. The equalizer configuration is based on the covariance matrix of interference. The control circuitry is configured to receive, from the network node, a message indicative of a transmit precoding information. The transmit precoding information is determined by the network node based on the raw pilot signals. The control circuitry is configured to determine a transmit precoding to be used by the device for transmitting communication signals to the network node. The transmit precoding is based on the transmit precoding information.

The device may be configured to perform the above-described method and the embodiments thereof.

According to the present invention, a further method for operating a device of a wireless multiple-input and multiple-output, MIMO, system is provided. The MIMO system provides a wireless communication between the device and a network node of the MIMO system. The method comprises determining an equalizer configuration to be used for receiving communication signals from the network node based on a covariance matrix of interference. The covariance matrix of interference is based on an interfering signal interfering the wireless communication in a receive direction of the device. Further, according to the method, a first transmit precoding is determined based on a Gram matrix and the covariance matrix of interference. The Gram matrix is indicative of an inner product of a channel matrix and the Hermitian conjugate of the channel matrix. The channel matrix is indicative of channel conditions of a wireless communication channel between the device and the network node Further, according to the method, from each individual antenna element of a plurality of antenna elements of the device, a respective precoded pilot signal using the first transmit precoding is transmitted. The precoded pilot signals are transmitted sequentially one after the other via the plurality of antenna elements to the network node. The device may have a single transmitter only. For example, the transmitter may be selectively coupled to any one of the plurality of antenna elements for transmitting the precoded pilot signals one after the other via the plurality of antenna elements. Transmitting precoded pilot signals may include for example transmitting each pilot signal with a specific amplitude defined in the first transmit precoding. Furthermore, transmitting precoded pilot signals may include that each pilot signal is transmitted with a specific phase defined in the first transmit precoding with respect to a predefined timing. Thus, although the precoded pilot signals are transmitted one after the other, the network node may be able to determine a phase of each of the precoded pilot signals based on the predefined timing. The network node may use these pilot signals for determining a transmit precoding used by the network node for transmitting communication signals from the network node to the device. A second transmit precoding for transmitting communication signals to the network node is determined at the device. The second transmit precoding is based on the Gram matrix and independent of the covariance matrix of interference. Thus, assuming an interfering signal which interferes essentially only the receive direction of the device, the first transmit precoding facilitates transmission of precoded pilot signals which considers the interfering signal such that the network node may configure a transmit precoding to be used by the network node for transmitting communication signals from the network node to the device such that the transmit precoding is optimized and fits to the equalizer configuration in the receive direction of the device. Consequently, a transmission of communication signals from the network node to the device is optimized considering the interfering signal. In the opposite direction, from the device to the network node, the device uses the second transmit precoding which is determined independent of the interfering signal as the interfering signal does essentially not affect the communication from the device to the network node. In case the device comprises a single transmitter only, the second transmit precoding may define one antenna element of the plurality of antennas to be used for transmitting communication signals to the network node.

The method may comprise detecting the interfering signal, which interferes the wireless communication, and determining the covariance matrix of interference based on the interfering signal. For example, the interference may be considered as a colored thermal noise. A noise-plus-interference profile may be determined for the multi-antenna device and the covariance matrix of interference may be determined based on a noise-plus-interference profile and the thermal noise. Considering the covariance matrix of interference when determining the equalizer configuration may reduce interference in the receive direction of the device and may thus improve reception.

The equalizer configuration may additionally be based on the first transmit precoding, for example based on reciprocity. Thus, channel characteristics of the wireless communication channel between the network node and the device are also included in the equalizer configuration thus improving reception.

In various embodiments, the second transmit precoding may be based on a transmitter configuration of the device. The transmitter configuration of the device may specify for example the number of transmitters or transmitter chains of the device, i.e. the transmitter configuration may be indicative of the number of radio signals which may be sent simultaneously from the plurality of antennas of the device.

The device may comprise a lower number of radio transmitters than the number of antenna elements of the plurality of antenna elements. The device may comprise a switching element configured to selectively couple at least one of the radio transmitters with either a first antenna element of the plurality of antenna element or a second antenna element of the plurality of antenna elements. For example, the device may comprise only a single radio transmitter and a switching element which is configured to selectively couple the single radio transmitter selectively with any one of the plurality of antenna elements.

According to various examples, the method may further comprise transmitting, from each individual antenna element of a plurality of antenna elements of the device, a raw pilot signal. The raw pilot signals are transmitted individually one after the other via the plurality of antenna elements. The network node may determine the Gram matrix based on the received raw pilot signals and may transmit the Gram matrix to the device. The Gram matrix is received at the device from the network node.

Thus, the precoded pilot signals may be used by the network node for determining a transmit precoding to be used by the network node for transmitting communication signals from the network node to the device. The raw pilot signals may be used by the network node for determining an equalizer configuration of the network node for receiving communication signals from the device. Furthermore, the second transmit precoding used by the device for transmitting communication signals from the device to the network node may be based on the Gram matrix which in turn is based on the raw pilot signals.

In further examples, the method comprises receiving, at the plurality of antenna elements of the device, a communication signal from the network node. The communication signal may comprise a payload or control communication signal from the network node, in particular a signal which may be transmitted using a transmit precoding determined at the network node based on the precoded pilot signals. Based on the communication signal received from the network node at the plurality of antennas, the device may determine the Gram matrix, for example by estimating channel characteristics of the radio channel between the network node and the device based on an adaption of phase and gain in the equalizer configuration for optimizing the power and signal-to-noise-ration of the communication signal received from the network node.

Furthermore, a device of a wireless multiple-input and multiple-output, MIMO, system is provided. The MIMO system provides a wireless communication between the device and a network node of the MIMO system. The device comprises control circuitry configured to determine an equalizer configuration to be used for receiving communication signals from the network node based on a covariance matrix of interference. The covariance matrix of interference is based on an interfering signal interfering the wireless communication in a received direction of the device. Furthermore, the control circuitry is configured to determine a first transmit precoding based on a Gram matrix and the covariance matrix of interference. The Gram matrix is indicative of an inner product of a channel matrix indicative of channel conditions of a wireless communication channel between the device and the network node and the Hermitian conjugate of the channel matrix. The control circuitry is configured to transmit, from each individual antenna element of a plurality of antenna elements of the device, a respective precoded pilot signal using the first transmit precoding. The precoded pilot signals are transmitted sequentially one after the other via the plurality of antenna elements. The device may comprise only a single transmitter for transmitting the precoded pilot signals. The single transmitter may be able to selectively couple to each of the plurality of antenna elements via for example a switching element. The network node may use the received precoded pilot signals for determining a transmit precoding to be used by the network node for transmitting communication signals from the network node to the device. The control circuitry is further configured to determine a second transmit precoding for transmitting communication signals to the network node. The second transmit precoding is based on the Gram matrix and independent of the covariance matrix of interference.

The device may be configured to perform the above-described method and the embodiments thereof.

According to various examples of, a further method for operating a device of a wireless multiple-input and multiple-output, MIMO, system is provided. The MIMO system provides a wireless communication between the device and a network node of the MIMO system. The method comprises determining an equalizer configuration based on a covariance matrix of interference. The equalizer configuration is to be used by the device for receiving communication signals from the network node. The covariance matrix of interference is based on an interfering signal interfering the wireless communication in a receive direction of the device.

Further, according to the method, a first transmit precoding is determined based on the covariance matrix of interference. The first transmit precoding may be determined additionally based on a Gram matrix. Further, according to the method, from each individual antenna element of a plurality of antenna elements of the device, a respective first precoded pilot signal is transmitted using the first transmit precoding. The first precoded pilot signals are transmitted simultaneously via the plurality of antenna elements to the network node. Transmitting first precoded pilot signals may include for example transmitting each pilot signal with a specific amplitude defined in the first transmit precoding. Furthermore, transmitting the first precoded pilot signals may include that each pilot signal is transmitted with a specific phase with respect to phases of the other pilot signals. The phases for each pilot signal are defined in the first transmit precoding. The network node may use these first pilot signals for determining a transmit precoding used by the network node for transmitting communication signals from the network node to the device. Thus, the transmit precoding used by the network node is aligned to the equalizer configuration of the device, and consequently the transmit precoding used by the network node and the equalizer configuration of the device both consider the interfering signal. In other words, assuming the interfering signal interferes essentially only the receive direction of the device, the first transmit precoding facilitates transmission of precoded pilot signals which consider the interfering signal such that the network node may configure a transmit precoding to be used by the network node for transmitting communication signals from the network node to the device such that the transmit precoding is optimized and fits to the equalizer configuration in the receive direction of the device. Thus, a transmission of communication signals from the network node to the device is optimized considering the interfering signal.

A second transmit precoding for transmitting communication signals from the device to the network node is determined. The second transmit precoding is based on a Gram matrix and independent of the covariance matrix of interference. According to the method, from each individual antenna element of a plurality of antenna elements of the device, a respective second precoded pilot signal is transmitted using the second transmit precoding. The second precoded pilot signals may be transmitted simultaneously from the plurality of antenna elements of the device. The second precoded pilot signals may be received by the network node. Based on the second precoded pilot signals, the network node may determine an equalizer configuration to be used when receiving communication signals from the device. Furthermore, the second transmit precoding may be used by the device for transmitting communication signals to the network node. Therefore, in the opposite direction, i.e. from the device to the network node, the device uses the second transmit precoding which is determined independent of the interfering signal as the interfering signal does essentially not affect the communication from the device to the network node. The equalizer configuration used by the network node for receiving the communication signals from the device is aligned to the second transmit precoding such that reception may be improved.

The Gram matrix is indicative of an inner product of a channel matrix and the Hermitian conjugate of the channel matrix. The channel matrix is indicative of channel conditions of a wireless communication channel between the device and the network node. The Gram matrix may be determined by the network node based on for example raw pilot signals from the device as will be described in more detail below.

It may be assumed that the Gram matrix changes only slowly such that an update of the Gram matrix may be performed less frequently than transmitting the first and/or second pilot signals. The Gram matrix determined by the network node may be communicated in a control message from the network node to the device.

To sum up, raw pilot signals, sent in the uplink, may facilitate the network node to estimate the channel matrix and the Gram matrix. The first precoded pilot signals, sent in the uplink, may facilitate the network node to estimate the downlink transmit precoding used by the network node based on the covariance matrix of interference. The second precoded pilot signals, sent in the uplink, may facilitate estimation of the uplink equalizer configuration use by the network node.

In particular, the second transmit precoding used by the device for transmitting communication signals to the network node may be determined as a vector x related to the antenna elements at the device. The vector x has a corresponding vector entry for each antenna element. In this context, vector x is also known as a beamforming vector. The vector x may be determined as the solution to:

$${\hat{W}}_{p} = arg {max}_{x} ( \frac{{x}^{H} Gx}{{x}^{H} x} ) ,$$

where G=HH^{H}, and H denotes the channel matrix. The expression says, let Wₚ be the x that maximizes the expression. G is the Gram matrix and H^{H} is the Hermitian conjugate of H.

The equalizer configuration used by the device for receiving communication signals from the network node may be determined as a vector y related to the antenna elements at the device. The vector y has a corresponding vector entry for each antenna element. The vector y may be determined as the solution to:

$${\hat{W}}_{e} = {max}_{y} ( \frac{{y}^{H} \sqrt{G} {R}^{H} \sqrt{G} y}{{y}^{H} y} ) .$$

Wₑ may be the y that maximizes the expression.

The method may comprise detecting the interfering signal, which interferes the wireless communication, and determining the covariance matrix of interference based on the interfering signal. For example, the interference may be considered as a colored thermal noise. A noise-plus-interference profile may be determined for the multi-antenna device and the covariance matrix of interference may be determined based on a noise-plus-interference profile and the thermal noise. Considering the covariance matrix of interference when determining the equalizer configuration may reduce interference in the received direction of the device and may thus improve reception.

The equalizer configuration used by the device may additionally be based on the first transmit precoding, for example based on reciprocity. Thus, channel characteristics of the wireless communication channel between the network node and the device are also included in the equalizer configuration thus improving reception.

As indicated above, the method may further comprise transmitting, from each individual antenna element of a plurality of antenna elements of the device, a raw pilot signal. The raw pilot signals may be transmitted simultaneously via the plurality of antenna elements. The network node may determine the Gram matrix based on the received raw pilot signals and may transmit the Gram matrix to the device, for example in a control message. The Gram matrix is received at the device from the network node.

Thus, the first precoded pilot signals may be used by the network node for determining a transmit precoding to be used by the network node for transmitting communication signals from the network node to the device. The raw pilot signals may be used by the network node for determining an equalizer configuration of the network node for receiving communication signals from the device. Furthermore, the second transmit precoding used by the device for transmitting communication signals from the device to the network node may be based on the Gram matrix which in turn is based on the raw pilot signals.

According to further examples, a device of a wireless multiple-input and multiple-output, MIMO, system is provided. The device may be configured to perform the above-described method and the embodiments thereof.

According to the present invention, a method for operating a network node of a wireless multiple-input and multiple-output, MIMO, system is provided. The MIMO system provides a wireless communication between a device of the MIMO system and the network node. The network node may comprise for example a base station and may be configured to communicate according to the so-called Long Term Evolution (LTE) cellular communication network standard. For example, the network node may comprise an eNB as defined in LTE or a gNB as defined in 5G NR. However, in various examples, the network node may comprise a terminal device, for example a mobile telephone, for example a so-called smartphone, for example in sidelink or hot-spot scenarios in which a terminal device comprises network node functionalities. Additionally or as an alternative, the network node of the present invention may be configured for a communication in a wireless local area network (WLAN), for example according to IEEE 806.11 standards. Additionally or as an alternative, the network node may act as a coordinated access point (AP) in for example an office building or an airport, or in a 3GPP NR.

The method comprises receiving, at a plurality of antennas of the network node, a plurality of raw pilot signals in orthogonal resources from the device. Although the network node may not recognize that the pilot signals are raw pilot signals, i.e. the pilot signals were transmitted without specific precoding, the network node may nevertheless know that they are raw pilot signals and may handle the raw pilot signals accordingly as described in the following. The network node may know that the pilot signals are raw pilot signals based on the resources in which the pilot signals are transmitted or based on a timing at which the pilot signals are received in a protocol procedure. Furthermore, according to the method, a message indicative of a covariance matrix of interference is received from the device. The covariance matrix of interference is determined by the device based on detecting an interfering signal interfering the wireless communication. Based on the plurality of raw pilot signals and the covariance matrix of interference a transmit precoding to be used by the network node for transmitting communication signals to the device is determined.

The method further comprises transmitting a message indicative of a transmit precoding information to the device. The transmit precoding information is indicative of a transmit precoding to be used by the device for transmitting communication signals to the network node. The transmit precoding information is based on the plurality of raw pilot signals. For example, the network node may determine a channel matrix indicative of channel conditions of a wireless communication channel between the device and the network node based on the plurality of raw pilot signals. Based on the channel matrix, the network node may determine the transmit precoding information. Thus, the network node may determine the transmit precoding which is to be used by the device, and may determine the transmit precoding information based on the transmit precoding. The transmit precoding to be used by the device may be determined by the network node such that it is independent of the covariance matrix of interference. The transmit precoding information may directly or indirectly indicate the transmit precoding to be used by the device as will be described in more detail in the following. Based on the transmit precoding information the device may extract or reconstruct the transmit precoding to be used by the device. Additionally, according to the method, an equalizer configuration to be used by the network node for receiving communication signals from the device is determined. The equalizer configuration is based on the plurality of raw pilot signals. The equalizer configuration to be used by the network node for receiving communication signals from the device may be determined such that it is independent of the covariance matrix of interference.

According to various examples, the method comprises determining a Gram matrix based on the channel matrix. The Gram matrix indicates an inner product of the channel matrix and the Hermitian conjugate of the channel matrix. The channel matrix indicates channel conditions of a wireless communication channel between the device and the network node. The transmit precoding information may be indicative of the Gram matrix. By providing the Gram matrix in the transmit precoding information, the device may determine, based on the Gram matrix, a corresponding transmit precoding to be used by the device for transmitting communication signals from the device to the network node.

It may be desirable for the network node to update the transmit precoding used by the network node for transmitting communication signals into the device. To accomplish this, the network node may transmit, to the device, a request for transmitting a further covariance matrix of interference, which has been updated by the device according to a present interfering signal. In response to the request, the network node may receive a further message indicative of the further covariance matrix of interference.

In various examples, the method may comprise receiving a message indicative of a transmitter configuration of the device. The transmitter configuration of the device may indicate a number of available transmitters in the device. The number of transmitters available in the device may restrict the number of antenna elements which may be simultaneously used by the device for transmitting precoded communication signals from the device to the network node. The network node determines the transmit precoding information, which indicates the transmit precoding to be used by the device, based on the transmitter configuration. For example, in case the device comprises less transmitters than antenna elements, the network node may indicate in the transmit precoding information which antenna elements are to be included in the transmit precoding. In case the device comprises only a single transmitter, the network node may indicate in the transmit precoding information which antenna element is to be used for transmitting communication signals from the device to the network node.

According to various examples, the raw pilot signals are received simultaneously via the plurality of antenna elements of the network node. For each raw pilot signal a respective amplitude is determined. Additionally, for each raw pilot signal a respective phase is determined. The phase of a raw pilot signal may be determined with respect to the predetermined timing. Additionally or as an alternative, the phase of a raw pilot signal may be determined with respect to phases of the other raw pilot signals, for example phase differences between the raw pilot signals may be determined. As a result, for each raw pilot signal a respective phase and a respective amplitude are determined. However, receiving the raw pilot signals simultaneously requires that the device provides at least a same number of transmitters as the number of antenna elements.

In case the device provides a lower number of transmitters than the number of antenna elements, the raw pilot signals may be received sequentially one after the other. The network node may determine a respective amplitude for each raw pilot signal. Furthermore, the network node may determine a respective phase for each raw pilot signal with respect to a predetermined timing. By reference to the predetermined timing, phase differences between the raw pilot signals resulting from different propagation delays and different propagation paths may be determined although the raw pilot signals were transmitted sequentially one after the other.

Phases or phase differences of the raw pilot signals as well as amplitudes of the raw pilot signals may be used for determining the channel conditions of the wireless communication channel between the device and the network node, and thus for determining the channel matrix and the Gram matrix.

A network node of a wireless multiple-input and multiple-output, MIMO, system is provided and comprises control circuitry. The MIMO system provides a wireless communication between a device of the MIMO system and the network node. The control circuitry is configured to receive, at a plurality of antennas of the network node, a plurality of raw pilot signals in orthogonal resources from a device of the MIMO system. The control circuitry is further configured to receive a message indicative of a covariance matrix of interference from the device. The covariance matrix of interference is determined by the device based on detecting an interfering signal interfering the wireless communication. The control circuitry is configured to determine a transmit precoding to be used by the network node for transmitting communication signals to the device. The transmit precoding is based on the plurality of raw pilot signals and the covariance matrix of interference. Further, the control circuitry is configured to transmit a message indicative of a transmit precoding information to the device. The transmit precoding information indicates a transmit precoding to be used by the device for transmitting communication signals to the network node. The transmit precoding information is based on the plurality of raw pilot signals. The transmit precoding for the device, which is indicated in the transmit precoding information, may be determined by the network node independent of the covariance matrix of interference. Additionally, the control circuitry is configured to determine an equalizer configuration to be used by the network node for receiving communication signals from the device. The equalizer configuration is based on the plurality of raw pilot signals.

The network node may be configured to perform the above-described method and the embodiments thereof.

According to further examples, a method for operating a network node of a wireless multiple-input and multiple-output, MIMO, system is provided. The MIMO system provides a wireless communication between a device of the MIMO system and the network node. The method comprises receiving, at a plurality of antennas of the network node, a plurality of pilot signals transmitted sequentially one after the other. The pilot signals may be transmitted from the device using a transmit precoding which considers an interfering signal interfering the communication between the network node and the device in a receive direction of the device. Thus, the plurality of pilot signals may be considered as a plurality of precoded pilot signals. For each pilot signal a respective amplitude is determined and further a respective phase with respect to a predetermined timing is determined. Furthermore, the method comprises determining a transmit precoding to be used by the network node based on the amplitudes and phases of the pilot signals. The transmit precoding may be used by the network node for transmitting a communication signal to the device. It is to be noticed that the transmit precoding to be used by the network node also considers the interfering signal when transmitting communication signals from the network node to the device using the transmit precoding.

In various examples, the method comprises receiving a plurality of raw pilot signals at the plurality of antennas of the network node. The raw pilot signals may comprise pilot signals transmitted from the plurality of antennas of the device sequentially one after the other. Based on the plurality of raw pilot signals the network node determines an equalizer configuration to be used by the network node for receiving communication signals from the device.

According to various examples, the method further comprises determining a Gram matrix based on the raw pilot signals. The Gram matrix indicates or comprises an inner product of a channel matrix and the Hermitian conjugate of the channel matrix. The channel matrix indicates channel conditions of a wireless communication channel between the device and the network node. The network node transmits the Gram matrix to the device. Based on the Gram matrix, the device may determine a transmit precoding, which is used by the device for transmitting communication signals from the device to the network node.

A network node of a wireless multiple-input and multiple-output, MIMO, system is provided and comprises control circuitry. The MIMO system provides a wireless communication between a device of the MIMO system and the network node. The control circuitry is configured to receive, at a plurality of antennas of the network node, a plurality of pilot signals transmitted sequentially one after the other from the device. The pilot signals may be transmitted from the device using a transmit precoding which considers an interfering signal interfering the communication between the network node and the device in a receive direction of the device. For each pilot signal a respective amplitude is determined. For each pilot signal a respective phase with respect to a predetermined timing is determined. A transmit precoding is determined based on the amplitudes and phases of the pilot signals.

The network node may be configured to perform the above-described method and the embodiments thereof.

According to various examples, a further method for operating a network node of a wireless multiple-input and multiple-output, MIMO, system is provided. The MIMO system provides a wireless communication between a device of the MIMO system and the network node. The method comprises receiving, at a plurality of antennas of the network node, a plurality of first pilot signals transmitted simultaneously from a plurality of antenna elements of the device. For each pilot signal of the plurality of first pilot signals a respective amplitude is determined and for each pilot signal of the plurality of first pilot signals a respective phase is determined. The first pilot signals are transmitted by the device using a first transmit precoding which is determined based on a covariance matrix of interference. The covariance matrix of interference is based on an interfering signal interfering the wireless communication in a receive direction of the device. The method further comprises determining a transmit precoding based on the amplitudes and phases of the first pilot signals. The network node may use the transmit precoding for transmitting communication signals from the network node to the device.

In various embodiments, the method may comprise receiving, at the plurality of antenna elements of the network node, a plurality of second pilot signals from the device. The second pilot signals may be transmitted from the device using a second transmit precoding. The second transmit precoding may be based on a Gram matrix and may be independent of the covariance matrix of interference. The second precoded pilot signals may be transmitted simultaneously from the plurality of antenna elements of the device. Based on the second pilot signals, the network node may determine an equalizer configuration to be used when receiving communication signals from the device.

The Gram matrix is indicative of an inner product of a channel matrix and the Hermitian conjugate of the channel matrix. The channel matrix is indicative of channel conditions of a wireless communication channel between the device and the network node. The Gram matrix may be determined by the network node based on for example raw pilot signals from the device. For example, the network node may receive at the plurality of antenna elements of the network node, raw pilot signal signals transmitted from the device. The raw pilot signals may be transmitted simultaneously via the plurality of antenna elements of the device. The network node may determine the Gram matrix based on the received raw pilot signals and may transmit the Gram matrix to the device, for example in a control message.

According to further examples, a network node of a wireless multiple-input and multiple-output, MIMO, system is provided. The network node may be configured to perform the above-described method and the embodiments thereof.

The devices of the present invention, for example the network node and/or the device, may be configured to communicate according to the so-called Long Term Evolution (LTE) cellular communication network standard. The device may comprise a mobile telephone, for example a so-called smartphone. Additionally or as an alternative, the devices of the present invention may be configured for a communication in a wireless local area network (WLAN), for example according to IEEE 806.11 standards. MIMO may also be supported by a network node in for example WLAN environments, for example in a base station. Additionally or as an alternative, the network node may act as a coordinated access point (AP) in for example an office building or an airport, or in a 3GPP NR.

According to embodiments, the MIMO system may be a massive MIMO system. The devices may include more than ten antenna elements, for example several tens of antenna elements or even in excess of 100 or 1000 antenna elements, to transmit and receive signals. Furthermore, the network node antenna elements may be distributed. The plurality of antenna elements may comprise several subsets located at several locations remote from each other. The several subsets may interact with each other in cooperative MIMO manner.

A MIMO system according to the present invention comprises at least one of the above described network nodes and at least one of the above described devices.

To sum up, the above described methods and devices enable a determination of transmit precodings and equalizer configurations in the network node and the device considering an interfering signal from an interferer which essentially influences the receive direction of the device only. In particular, the resulting equalizer configuration to be used by the device considers the interfering signal such that the interfering signal is essentially attenuated or nullified by the equalizer configuration. For example, the equalizer configuration of the device may be determined such that a receive characteristic is not sensitive to signals in the direction of the interferer. The transmit precoding used by the network node is adapted to the equalizer configuration to be used by the device. In the opposite transmission direction, which is essentially not affected by the interfering signal, the transmit precoding to be used by the device does not consider the interfering signal The equalizer configuration to be used by the network node is adapted to the transmit precoding to be used by the device. Thus, in both directions, a transmission may be improved.

As a general rule, roles of the network node and the device may be exchanged, for example in case the interfering signal essentially influences a receive direction of the network node. Furthermore, the network node and the device may both represent terminal devices operated in the MIMO system, using for example a so-called sidelink communication.

Although specific features in the above summary and the following detailed description are described in connection with specific embodiments and aspects of the present invention, it should be understood that the features of the exemplary embodiments and aspects may be combined with each other unless specifically noted otherwise. In particular, the assignment of the roles in several examples that the device is the device which detects the interfering signal and transmits pilot signals such that the network node may establish a transmit precoding which is different from an equalizer configuration, may be reversed such that the network node detects the interfering signal and transmits pilot signals such that the device may establish a transmit precoding which is different from the equalizer configuration.

### BRIEF DESCRIPTION OF THE DRAWINGS

Embodiments of the invention will be described in more detail with reference to the accompanying drawings.

FIGS. 1 and 2 show schematically a MIMO system comprising a network node and a device according to embodiments of the present invention.

FIG. 3 shows a device according to embodiments of the present invention.

FIG. 4 shows a device according to other embodiments of the present invention.

FIGS. 5 to 7 show flowcharts of a method performed by a device and a method performed by a network node according to embodiments of the present invention.

FIGS. 8 and 9 show flowcharts of a method performed by a device and a method performed by a network node according to further embodiments of the present invention.

FIGS. 10 and 11 shows flowcharts of a method performed by a device and a method performed by a network node according to various examples.

### DETAILED DESCRIPTION OF THE EMBODIMENTS

In the following, exemplary embodiments of the present invention will be described in more detail. It is to be understood that the features of the various exemplary embodiments described herein may be combined with each other unless specifically noted otherwise. Any coupling between components or devices shown in the figures may be a direct or indirect coupling unless specifically noted otherwise.

Multiple-input and multiple-output (MIMO) systems, in particular massive MIMO systems, may use TDD as well as FDD. TDD provides the possibility to use reciprocity in (massive) MIMO systems, for example for both FR1 and FR2 in 5G NR. In 5G NR Frequency Range 1 (FR1) may include sub-6 GHz frequency bands, and Frequency Range 2 (FR2) may include frequency bands from 24.25 GHz to 52.6 GHz. An inherent problem with TDD systems compared to FDD systems is the interference. For example, during downlink (DL), a terminal device (user equipment, UE) in a TDD system may experience desensitization from other UEs unless UL and DL are synchronized both inter and intra cell. This is challenging and there will be situations where this cannot be fully satisfied. The situation in FR2 systems is slightly better due to the introduction of array antennas at the UE side. The resulting beamforming improves the antenna gain in the direction of the network node (for example an access node) and at the same time attenuates interferers from other directions.

For a TDD system it may be desirable to keep the interference low during DL communication. If there is an interferer present, a terminal device will experience desensitization and either the network node needs to increase the power, or the link may be lost. Increasing the power at the network node may be problematic as the overall interference level to other terminal devices will increase causing the system throughput to decrease. An alternative approach is that the terminal makes use of its multiple antennas (at least in receive mode) to create null(s) in the direction of the interferer(s) and thereby increasing the signal-to-interference-and-noise-ratio (SINR). Interference may typically be considered as colored noise. If the noise-plus-interference profile can be determined the interference can be mitigated and the reception improved. The noise-plus-interference profile relates to the ratio between Gaussian noise and interference, which may be described in a noise-plus-interference covariance matrix. For example, in a MIMO system, for each resource element a corresponding noise-plus-interference covariance matrix may be determined and the “profile” defines the underlying structure of all those matrices.

For example, the noise-plus-interference profile for a multi-antenna terminal device may be given by (I*N₀+R), where R is the covariance matrix of the interference, No is the thermal noise, and I is the unity matrix, i.e. a diagonal matrix of appropriate size with 1's along the diagonal. When I is multiplied with the scalar No, a diagonal matrix with N₀ along the diagonal is obtained. Appropriate size means same size as R.

A terminal device may estimate the value of N₀, and may determine (I*N₀+R).

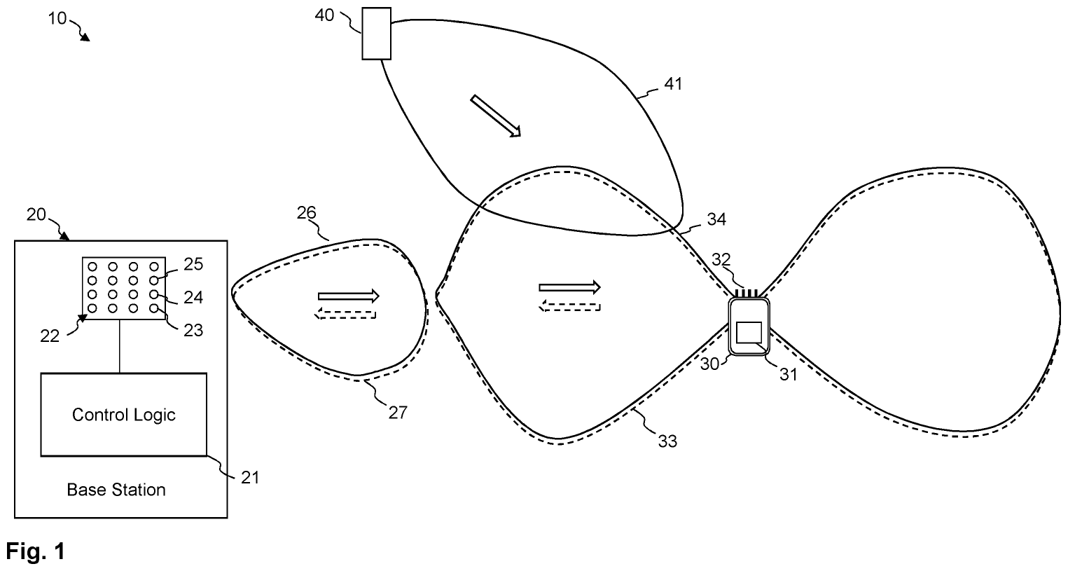

FIG. 1 shows schematically a wireless multiple-input and multiple-output (MIMO) system 10 comprising a network node 20, for example a base station, and a network device 30, for example a terminal device. The MIMO system 10 may comprise a plurality of further network devices, which are served by the network node 20 but not shown in the figure for clarity reasons. The network node 20 comprises an antenna array 22 including a plurality of antenna elements, of which three are indicated by reference signs 23 to 25. The network node 20 may have a large number of antenna elements 23 to 25, such as several tens or in excess of one hundred or one thousand antenna elements. The antenna elements 23 to 25 may be arranged in a two- or three-dimensional spatial array on a carrier. The network node 20 also comprises associated transceivers for the antenna elements 23 to 25. The plurality of antenna elements may also be spatially distributed to various locations, for example in cooperative MIMO. It is also possible that several network nodes interact in cooperative MIMO, with the plurality of antenna elements being distributed over various locations.

The network node 20 is configured to analyze a pilot signal received from the terminal device 30 at the plurality of antenna elements 23 to 25 to determine channel characteristics for a radio signal transmission between the plurality of antenna elements 23 to 25 and the terminal device 30. For illustration, a control circuitry 21 of the network node 20 may be configured to determine a footprint matrix based on a pilot signal received by the plurality of antenna elements 23 to 25 from a terminal device. The control circuitry 21 may use the footprint matrix to control the plurality of antenna elements 23 to 25 when transmitting radio signals to the terminal device 30. The control circuitry 21 may compute a Hermitian conjugate of the footprint matrix to determine time delays and amplitudes of radio signals transmitted by each of the plurality of antenna elements 23 to 25 to focus radio energy in a sector in which the terminal device 30 is located. The control may be performed in such a way that focusing of radio energy is not only performed as a function of the direction, but also as a function of distance from the network node 20. A radio signal transmitted by the plurality of antenna elements 23 to 25 in the above-described manner with individually assigned delays and amplitudes to each antenna element is called “precoded radio signal”. The set of parameters for assigning delays and amplitudes to each antenna element is called “transmit precoding”. This transmit precoding enables the network node 20 to communicate with multiple terminal devices simultaneously using the same time and frequency resources, as the multiple terminal devices are addressed by a spatial multiplexing.

In the receive direction, the control circuitry 21 may assign corresponding delays and gains or weightings to each antenna element 23-25 for adjusting a sensitivity of the antenna array 22 with respect to radio signals transmitted from the terminal device 30. The set of parameters for assigning delays and gains to each antenna element is called “equalizer configuration”. The equalizer configuration is also known as “receive precoding”. The equalizer configuration may be considered as providing a filtering and combining of the radio signals received at the plurality of antenna elements 23 to 25. The equalizer configuration enables the network node 20 to communicate with a plurality of terminal devices simultaneously using the same time and frequency resources, as the radio signals from the plurality of terminal devices may be distinguished by spatial multiplexing. For example, the time and frequency resources may be defined in a frame of the MIMO system, for example a resource block defined in a frequency division duplexing (FDD) LTE frame or in a time division duplexing (TDD) LTE frame in a cell of an LTE system.

The device 30 shown in FIG. 1 also comprises a plurality of antenna elements. As an example, the terminal device 30 may comprise four antenna elements, which are indicated by reference sign 32. As described above in connection with the network node 20, the terminal device 30 may comprise transceivers and a control circuitry 31 to provide a transmit precoding and/or equalizer configuration when transmitting and/or receiving radio signals by the plurality of antenna elements 32. The transmit precoding may assign to each antenna element 32 a corresponding individual delay (phase) and amplitude (gain). Likewise, the equalizer configuration may assign to each antenna element 32 a corresponding individual delay (phase) and amplitude (gain).

FIG. 1 shows an antenna transmit pattern 33 (indicated by the dashed line) generated by a radio signal transmitted from the plurality of antenna elements 32 using a transmit precoding for directing the radio signal to the antenna array 22 of the network node 20 and optimizing the radio signal for reception by the antenna array 22 of the base station 20. Additionally, FIG. 1 shows an antenna receive pattern 34 (indicated by the solid line), which indicates the reception sensitivity of the plurality of antenna elements 32 when receiving a radio signal using the equalizer configuration, which optimizes the reception sensitivity with respect to the antenna array 22 of the network node 20. The transmit precoding may be generated based on reciprocity of the equalizer configuration, which is generated based for example on a channel sounding of the radio channel between the network node 20 and the terminal device 30 with pilot signals.

FIG. 1 also shows an antenna transmit pattern 26 (indicated by the solid line) generated by the radio signals transmitted from the plurality of antenna elements 23 to 25 of the antenna array 22 of the network node 20 using a transmit precoding for directing the radio signals to the antenna elements 32 of the device 30 and optimizing the radio signals for reception by the antenna element 32 of the device 30. FIG. 1 also shows an antenna receive pattern 27 (indicated by the dashed line) indicating the reception sensitivity of the plurality of antenna elements 23 to 25 of the antenna array 22 of the network node 20 when receiving a radio signal using the equalizer configuration, which optimizes the reception sensitivity with respect to the antenna elements 32 of the device 30. The characteristics of the radio channel between the terminal device 30 and the network node 20 may be determined based on a channel sounding using pilot signals. The transmit precoding as well as the equalizer configuration may be determined based on the radio channel characteristics.

Furthermore, FIG. 1 shows a device 40 which generates an interfering radio signal. Device 40 may comprise for example another terminal device of the MIMO system or of another wireless communication system, or the device 40 may comprise another network node, for example another base station or another access point of the MIMO system or another wireless communication system. The interfering radio signal may have a transmit pattern 41 as indicated by the solid line in FIG. 1. As can be seen from FIG. 1, the transmit pattern 41 of the interfering radio signal is overlapping with the antenna receive pattern 34 of the terminal device 30. Therefore, a radio signal transmitted from the network node 20 and received by the terminal device 30 is disturbed by the interfering radio signal of device 40. Due to the directivity of the interfering radio signal, only the downlink direction from the network node 20 to the terminal device 30 is influenced by the interfering radio signal, whereas the uplink direction from the terminal device 30 to the network node 20 is not or minor influenced by the interfering radio signal. Therefore, in such a situation, a transmit precoding resulting in the same or similar transmit pattern as the receive pattern resulting from a reciprocal equalizer configuration does not provide an optimum transmission in both directions, uplink and downlink.

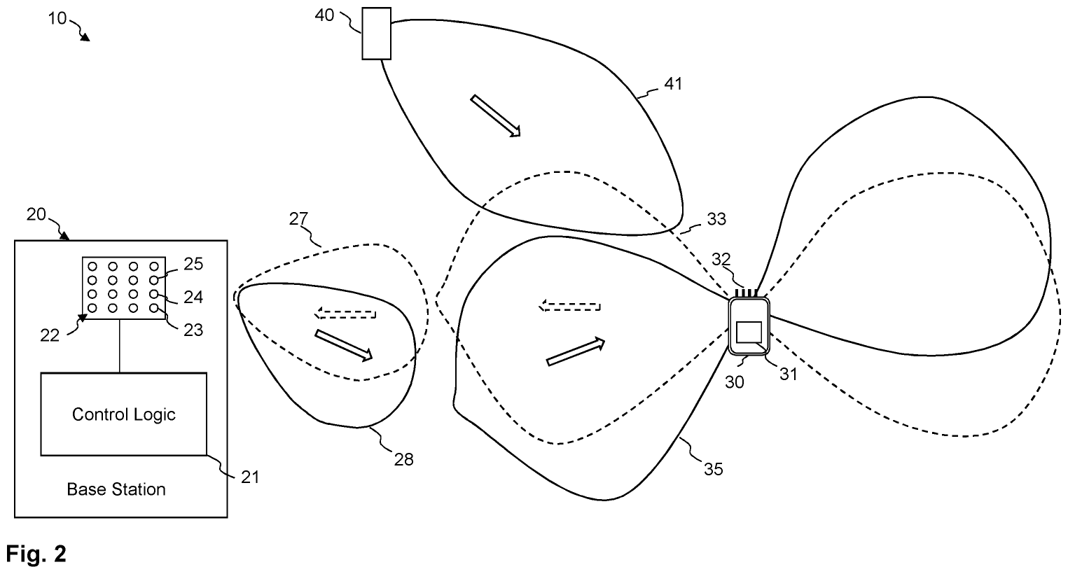

FIG. 2 shows a similar arrangement of the devices 20, 30 and 40 as FIG. 1. However, in FIG. 2, the terminal device 30 has a different receive pattern 35, which considers the interfering radio signal from the device 40. In this example, the receive pattern 35 is tilted such that the antenna elements 32 of the terminal device 30 are less or not sensitive to the interfering signals from the device 40. Meanwhile, the transmit pattern 33 is the same as the transmit pattern 33 shown in FIG. 1. Therefore, uplink transmissions from the terminal device 30 to the network node 20 benefit from an optimum adaption to the actual channel characteristics, whereas the downlink transmissions may not be received with an optimum concerning channel characteristics, but essentially exclude deterioration from the interfering radio signal. Additionally, the network node 20 may adapt its downlink transmit precoding such that the tilted receive pattern 35 of the terminal device 30 is considered to increase signal strength and signal-to-noise ratio. As shown in FIG. 2, the adapted transmit precoding used by the network node 20 may result in a transmit pattern 28, whereas the received pattern 27 is essentially unchanged compared with the received pattern 27 of FIG. 1.

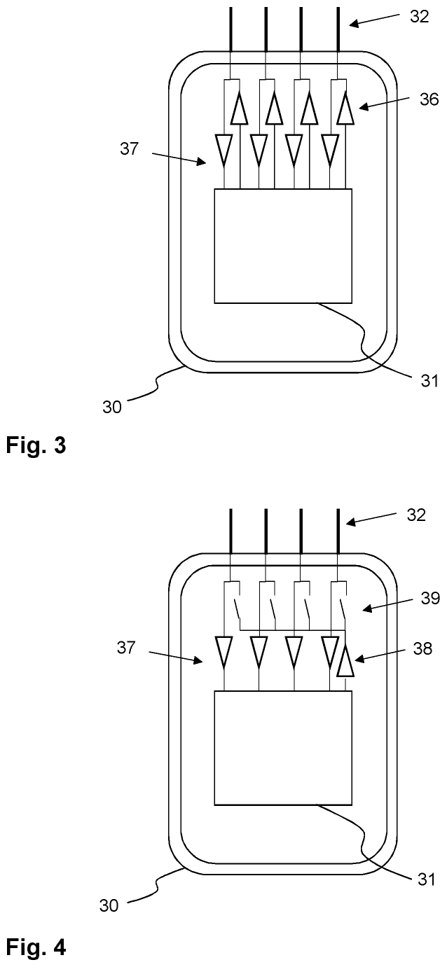

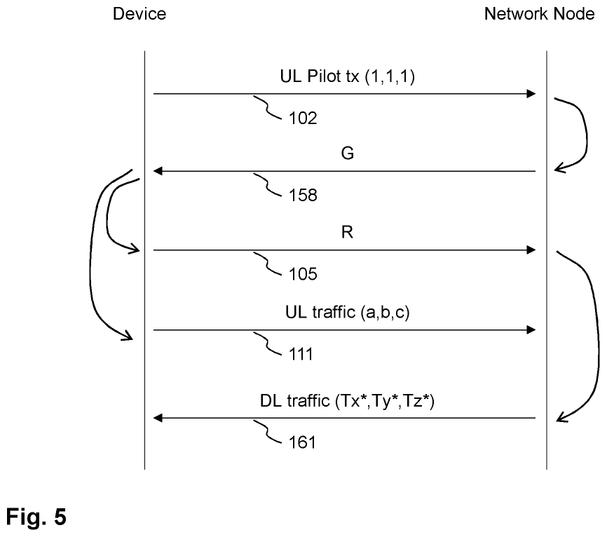

For accomplishing the above-described receive and transmit pattern adaption considering the interfering radio signal, the device 30 and the network node 20 employ channel sounding and precoder and equalizer configuration procedures as will be described below in connection with FIGS. 5 to 11. However, further aspects may be considered, for example a transmitter configuration of the device 30, as will be discussed below in connection with FIGS. 3 and 4.

It is to be noticed that the receive and transmit patterns shown in FIG. 1 and FIG. 2 are only illustrative examples for explaining the principles of the present invention. According to these principles, in the downlink direction, the receive pattern of the device 30 is modified such that it essentially nullifies or attenuates the interfering signal from the device 40, and the corresponding transmit pattern from the network node 20 is optimized to cooperate with the modified received pattern of the device 30. In the uplink direction, the transmit pattern of the device 30 may be configured such that it is optimized to the channel properties without considering the interfering signal from the device 40. The receive pattern of the network node 20 is optimized to cooperate with the transmit pattern of the device 30. In particular, in typical implementations, the receive and transmit patterns may be more complex, for example comprising a plurality of side lobes.

FIG. 3 shows details of an example of the device 30. The device 30 comprises the control circuitry 31 and for each antenna element 32 an assigned transmitter 36 and an assigned receiver 37. Thus, the device 30 may transmit simultaneously via each antenna element 32 a corresponding radio signal having an individual amplitude and phase. Furthermore, the device 30 may receive simultaneously via each antenna element 32 a corresponding radio signal and may process each received radio signal with a corresponding phase and amplitude (gain).

However, in particular mobile devices having requirements concerning low power consumption, lower cost and small design, may have a lower number of transmitters than a number of antenna element 32. In the example shown in FIG. 4, the device 30 comprises for each antenna element 32 an assigned receiver 37, but only one single transmitter 38. Additionally, the device 30 comprises a switching element 39, which enables the single transmitter 38 to be selectively coupled with one or more of the antenna element 32. Thus, the device 30 may receive simultaneously via each antenna element 32 a corresponding radio signal and may process each received radio signal with a corresponding phase and amplitude (gain). However, due to the single transmitter 38, the device is capable of transmitting only a single radio signal having a certain amplitude and phase via one or more of the antenna element 32 at a time. The coupling between the transmitter 38 and the antenna element 32 may be dynamically configurable under control of the control circuitry 31 such that in operation of the device 30 the assignment between the transmitter 38 and each of the antenna elements 32 can be configured dynamically. The device 30 may have more than one transmitter, but a lower number of transmitters than number of antenna elements 32. For example, the device 30 may have two transmitters 38 and four antenna elements 32. The switching element 39 may provide a dynamic assignment between the two transmitters 38 and the four antenna elements 32 such that two individually configured radio signals having an individual phase and amplitude can be transmitted simultaneously via any two of the antenna elements 32 as defined by the switching element 39.

To sum up, a terminal device with multiple antennas operating in a massive MIMO system, employing for example single stream communication in both uplink and downlink, may thus need to find a transmit precoding to be used for uplink transmission, and find an equalizer configuration to be used for downlink reception.

Likewise, the network node needs to find a correspondingly adapted transmit precoding for downlink transmission and a correspondingly adapted equalizer configuration for uplink reception.

In general, the transmit precoding may be represented by a precoding vector comprising an entry for each antenna element. Each entry of the vector may comprise for example an amplitude and phase to be used in connection with the corresponding antenna element when transmitting radio signals.

The equalizer configuration may be represented by an equalizer vector comprising an entry for each antenna element with each entry of the vector comprising for example an amplitude and phase to be used in connection with the corresponding antenna element when receiving radio signals.

The vectors that are involved in the following relate to the antenna elements at the terminal device. However, with swapped roles of the terminal device and the network node, the vectors may also relate to the antenna elements at the network node. For example, at a terminal device with three antennas, the vector is 3×1, at a terminal device with four antennas, the vector is 4×1 etc.

Interference, for example received at the terminal device, is a well studied scenario in 3GPP. For example, in LTE Rel-11, the “Further enhanced Inter-Cell Interference Coordination” (feICIC) feature was introduced for the case where R is not a scaled identity. A physical scenario may be for example a scenario in which another network node (for example a gNB, for example device 40) interferes a terminal device 30 as shown in FIGS. 1 and 2. The feICIC specifies the information that the serving cell, for example network node 20, needs to provide the terminal device 30 in order for the terminal device 30 to estimate R. The information may include a number of interfering layers transmitted, a cell-ID of interferer(s), a time-frequency layout of the interfering cell(s). The serving cell network node 20 may obtain this information based on a backhaul to the interfering device or node 40.

If R is a scaled identity matrix, the interferer cannot be nullified or attenuated by a specific equalizer configuration. If R is not a scaled identity matrix, i.e. if there are off diagonal elements in R or if the diagonal elements of R are not all identical, an equalizer configuration with a better SINR may be found which nullifies or attenuates the interference.

In detail, if the interference covariance matrix R is a scaled identity, the precoding and equalizer vectors are the same, and this vector is the solution to

$${\hat{W}}_{p} = arg {max}_{x} ( \frac{{x}^{H} Gx}{{x}^{H} x} ) , \qquad ( 1 )$$

where G=HH^{H}, and H denotes the DL channel matrix. x is the precoding vector. According to expression (1), Wp is the x that maximizes the expression, i.e. the transmit precoding that gives the strongest channel. G is the inner product (also known as Gram matrix) and H^{H} is the Hermitian conjugate of H.

If the interference covariance matrix R is not a scaled identity matrix, then the precoding and equalizer vectors may not be the same. The optimal UL precoding vector may remain the same as before, but the optimal equalizer vector changes.

While the optimal equalizer vector Ê may be computed as the left singular vector associated with the strongest singular value of the matrix

R^{-1/2}HH^{H}R^{-H/2} (2)

this equalizer vector requires that another UL precoding vector is applied for determining DL precoding at the network node than the optimal one mentioned above. For determining the DL precoding at the network node, it is optimal to use the following UL precoding vector

$${\hat{W}}_{e} = {max}_{x} ( \frac{{x}^{H} \sqrt{G} {R}^{H} \sqrt{G} x}{{x}^{H} x} ) . \qquad ( 3 )$$

To sum up:
For UL communication, optimal data rate is achieved if the terminal device UL precoder is determined according to Ŵₚ defined in (1).
For DL communication, optimal data rate is achieved if the terminal device DL equalizer is determined according to Ê defined in (2), and the precoder is determined according to Ŵₑ defined in (3).

In other words, when the terminal device transmits uplink data, it should precode the data using the precoder Ŵₚ in (1). The network node should decode the data on the basis of the equalizer vector that is observed for terminal device precoder Ŵₚ. When the terminal device receives data, the network node should precode the data on the basis of the channel vector that is observed if the terminal uses Ŵₑ in (3). In the following, this is accomplished by selecting a third precoder (actually a set of precoders) that is used by the terminal device that allows the network node to equalize (UL) and precode (DL) optimally.

In connection with FIGS. 5-7, a method for a device and a method for a network node are described.

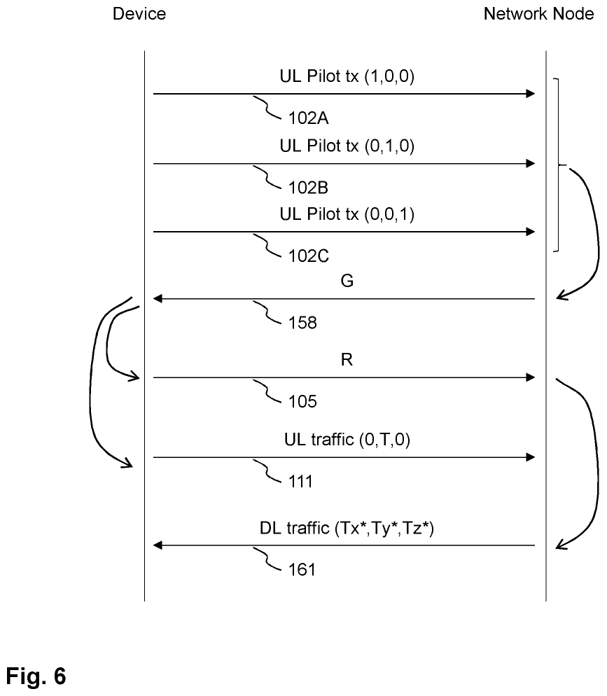

In summary, according to this method and illustrated in connection with FIGS. 5 and 6, the optimal transmit precoder for the device are not derived by the device itself, but derived at the network node and communicated to the device. FIG. 5 illustrates an overview of the principles of this method for an exemplary terminal device with three antenna elements and three transmit chains. FIG. 6 illustrates an overview of the principles of this method for an exemplary terminal device with three antenna elements, but only a single transmit chain. The network node receives raw pilot signals transmitted (see steps 102, 102A, 102B and 102C) from each antenna element of the device.

A raw pilot signal is a pilot signal which is transmitted without precoding, i.e. a pilot signal which is transmitted from one antenna element without a specific phase with respect to pilot signals transmitted from the other antenna elements to achieve a certain intended directionality in combination with pilot signals from the other antenna elements, e.g. beamforming. However, the phases or at least relative phases, with which the raw pilot signals are transmitted by the terminal device, must be known to the network node to be able to determine phase differences induced by the radio channel between the terminal device and the network node. Likewise, the amplitudes of the raw pilot signals may be arbitrarily selected, but must be known to the network node. For example, the raw pilot signals may be transmitted from the plurality of antenna elements with the same phase and the same amplitude. Thus, a raw pilot signal is a pilot signal with a known phase and amplitude (as compared to that from the other antennas) transmitted from an antenna.

For achieving orthogonally, each pilot signal may be transmitted in a respective dedicated time-frequency resource. In case the device provides for each antenna element a corresponding transmitter, the raw pilot signals may be transmitted simultaneously from the antenna elements (see the step 102 in FIG. 5), i.e. a raw pilot signal is transmitted from a first antenna element simultaneously with a transmission of a raw pilot signal from a second antenna element simultaneously with a transmission of a raw pilot signal from a third antenna element and so on, but in different resource elements within a coherence block, i.e. different frequencies within the coherence bandwidth. In case the device provides less transmitters than antenna elements, the raw pilot signals may be transmitted sequentially one after the other from the antenna elements of the device with respect to a predefined timing scheme (see the step 102A, 102B and 102C in FIG. 6), for example with the same phase to the timing scheme. The predefined timing scheme is also known at the network node and the network node may determine a phase of each received raw pilot signal with respect to the predefined timing scheme. The device may share a covariance matrix of interference R with the network node in step 105. Based on the covariance matrix of interference R and the raw pilot signals, the network node may determine a transmit precoding (for example weighting coefficients and phases for each antenna element of the network node) to be used by the network node for transmitting communication signals from the network node to the device in step 161. For example, the network node can determine a Gram matrix G based on the raw pilot signals and in connection with the covariance matrix of interference R, the network node can determine Ŵₑ defined in (3). The Gram matrix G may be transmitted to the terminal in step 158 for determining a transmit precoding to be used by the device for uplink traffic in step 111. Assuming that the interference changes slowly, R can be updated at a slower rate than the transmission of the raw pilot signals. In case the device has a single transmitter only, for the UL traffic a single antenna associated with the strongest link can be used in step 111. In the brackets in FIGS. 5 and 6, the transmit precoding and the equalizer configuration to be applied at the device are indicated for each antenna element. x* is the conjugate of x. Instead of deriving G at the network node, G may be determined at the terminal device and shared over the control channel with the network node. It is important to note that both, the network node and the device, use the same Gram matrix G.

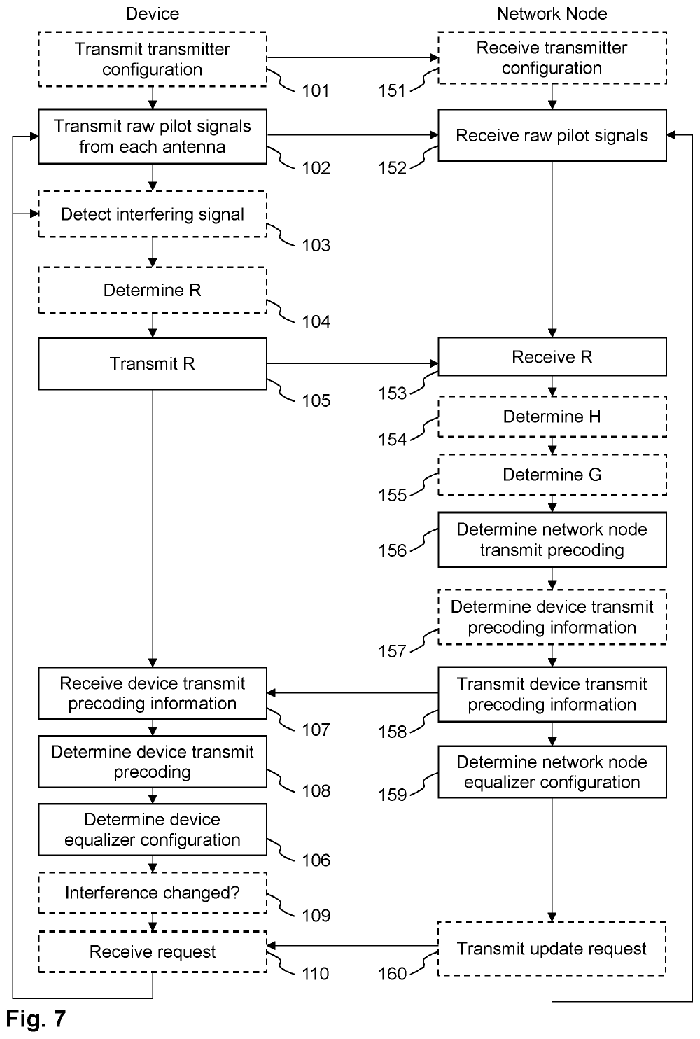

In detail, according to this method as shown in FIG. 7, the device 30 may perform method steps 101 to 110, and the network node 20 may perform method steps 151 to 160. In particular, steps 101, 103, 104, 109, 110, 151, 154, 155, 157 and 160 shown as dashed boxes may be optional.

In step 101 the device 30 transmits a message which indicates a transmitter configuration to the network node 20. The transmitter configuration may comprise for example an indication indicating a number of the transmitters which can be used by the device 30 simultaneously for transmitting radio signals, for example payload data signals, control data signals or pilot signals. The message may additionally include information concerning a receiver configuration of the device 30, for example a number of receivers which can be used by the device 30 simultaneously for receiving radio signals. The message may also include information concerning an antenna configuration of the device, for example a number of antennas which can be individually be used by the receivers and transmitters.

In step 151 the network node receives the transmitter configuration from the device 30 and may store the transmitter configuration for handling radio signals from the device correspondingly as will be described below in more detail. The transmitter configuration may be stored in connection with a device ID of the device 30. Furthermore, the transmitter configuration may be communicated between the device 30 and the network node 20 during registering of the device 30 at the network node 20.

In step 102, the device 30 transmits raw pilot signals from the plurality of antenna elements 32. From each antenna element 32 a respective raw pilot signal is transmitted in orthogonal resources. In case the device 30 comprises a same number of transmitters 36 as a number of antenna elements 32 as shown in FIG. 3, the raw pilot signals may be transmitted simultaneously. Transmitting “raw” pilot signals may mean for example that from each antenna element 32 a pilot signal with a same amplitude is transmitted and that there is no phase offset between the transmission of the pilot signals. However, due to different propagation delays and different propagation paths of the pilot signals, the network node 20 may receive each of the pilot signals with a different phase and a different amplitude. Orthogonality may be obtained for example by transmitting the pilot signals at different frequencies or by using different symbol codings such that the network node can distinguish the pilot signals. In case the device 30 comprises less transmitters than antenna elements 32 as shown in FIG. 4, in particular in case the device 30 comprises only one single transmitter 38, the raw pilot signals may be transmitted subsequently one after the other via the antenna elements 32. However, the raw pilot signals may be transmitted with respect to a predefined timing scheme such that the network node 20 may determine, during receiving the raw pilot signals, different propagation delays and such a resulting phase offset between the raw pilot signals from the different antenna elements 32.

In step 152 the network node receives the raw pilot signals and determines for each pilot signal a corresponding phase and amplitude, which will be used for determining channel characteristics of a radio channel between the network node 20 and the device 30.

In step 103 the device 30 detects an interfering signal which may interfere the wireless communication between the base station 20 and the device 30. For example, the interfering signal may comprise radio signals from the device 40 as shown in FIGS. 1 and 2. The interfering signal may essentially interfere the communication from the base station 20 to the device 30, i.e. the downlink communication. The device 30 may determine, in step 104, a covariance matrix of interference R based on the interfering signal, for example as described above by using feICIC information provided by the base station 20 via a not shown control message or during registering. In step 105 the device 30 transmits the covariance matrix of interference R to the network node 20, for example in a control message.

The network node receives the covariance matrix of interference R in step 153.

Based on the received pilot signals, the network node 20 determines in step 154 a channel matrix H which indicates channel conditions of the radio channel between the device 30 and the network node 20. Additionally, in step 155, the network node may determine a Gram matrix G based on the channel matrix H. The Gram matrix may be computes as the inner product of the channel matrix H.

Based on the received pilot signals and the covariance matrix of interference R, the network node determines in step 156 a transmit precoding to be used by the network node 20 when transmitting communication signals from the network node 22 the device 30. For example, the transmit precoding may be configured such that, when used by the network node 20, a communication signal transmitted from the antenna array 22 has the transmit pattern 28 as shown in FIG. 2.

Based on the channel matrix H and the Gram matrix G, the network node 20 determines in step 157 a transmit precoding information indicating a transmit precoding to be used by the device 24 for transmitting communication signals from the device 20 to the network node 30. For example, the transmit precoding may be configured such that, when using the transmit precoding at the device 30, a transmission from the device 30 may have the transmit pattern 33 shown in FIG. 2. In step 158, the network node 20 may transmit precoding information to the device 20. The transmit precoding information may also include the Gram matrix G or may include information indicative of the Gram matrix G for the device to determine the Gram matrix G based thereon. The Gram matrix G may also be transmitted from the network node to the device in a separate message.

Furthermore, based on the plurality of received pilot signals, the network node 20 determines in step 159 an equalizer configuration be used by the network node 24 for receiving communication signals from the device 20. For example, the equalizer configuration may be configured such that a receive characteristic of the antenna array 22 corresponds to the received pattern 27 when the equalizer configuration is applied to receivers of the network node 20.

In step 107, the device 20 receives the transmit precoding information from the network node 20. The transmit precoding information indicates a transmit precoding to be used by the device 20 for transmitting communication signals from the device 20 to the network node 30. In step 108, the device 20 determines the transmit precoding based on the received transmit precoding information. For example, the transmit precoding information may be indicative of the Gram matrix G and the device 20 may determine the transmit precoding based on the Gram matrix G. In other examples, the transmit precoding information may directly indicate the configuration for the transmit precoding. In other examples, a set of transmit precodings may be predefined in the MIMO system 10 and the transmit precoding information comprises an indicator indicating one of the predefined transmit precodings. In case the device 30 comprises only a single transmitter 38 as shown in FIG. 4, the transmit precoding information may indicate the antenna element to be used for transmitting communication signals.

In step 106, the device 20 determines an equalizer configuration to be used by the device 20 based on the covariance matrix of interference R and the Gram matrix G. The equalizer configuration may be configured such that, when applied to the receivers 37 of the device 20, the antenna elements 32 have the receive characteristic as indicated by receive pattern 35 shown in FIG. 2. Thus, interference from device 40 may be nullified or at least attenuated.

The transmission of the raw pilot signals (steps 102 and 152) may be repeated in regular terms. Likewise, the transmission of the covariance matrix of interference R (steps 105 and 153) may be repeated in regular terms or upon request. Therefore, the method may be restarted at steps 102 and 152, respectively. The raw pilot signals may be transmitted more frequently than the covariance matrix of interference R. In this case, some steps may be skipped, for example steps 103 to 105 and 153. Updating of the covariance matrix of interference R may be initiated for example when the device 30 determines in step 109 a change of the interference from the device 40. In other examples, the network node 20 may transmit in step 160 an update request to the device 30, which is received in step 110. Upon receiving the update request, the device 30 may perform at least the steps 103 to 105.

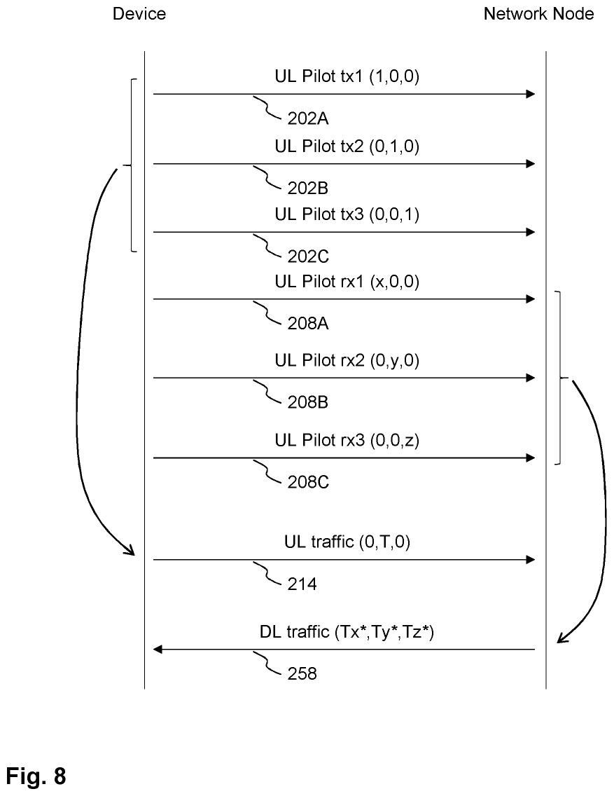

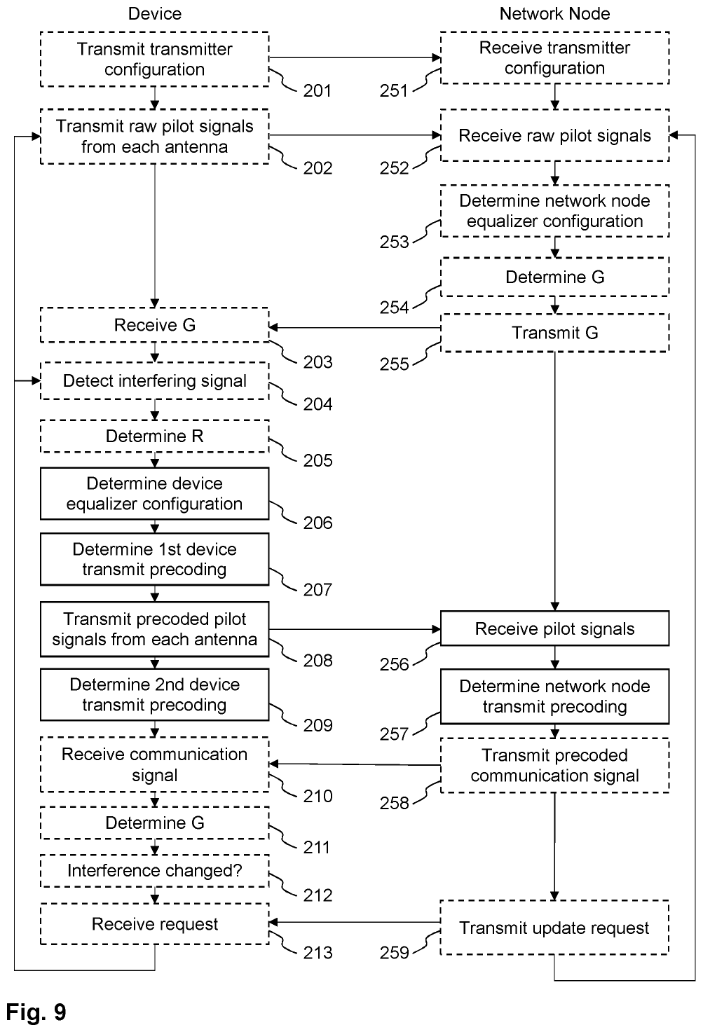

FIGS. 8 and 9 show a further method for a device and a further method for a network node. The device has a lower number of transmitters than a number of antenna elements, for example the device has only a single transmitter as shown in FIG. 4. FIG. 8 illustrates an overview of the principles of this method for an exemplary terminal device with three antenna elements, but only a single transmit chain. According to these principles, the terminal device derives the optimal transmit precoder and communicates this to the network node. Assuming that the terminal device has estimates of both G and R, based thereon the terminal device can compute Ŵₑ according to (3). For the exemplary case that the terminal device has three antenna elements, it may be assumed Ŵₑ=[x, y, z], where x, y, and z are complex valued weight coefficients (assuming ∥Ŵₑ∥²=P the precoder power). As pilot signals according to this vector cannot be transmitted by the terminal device (single transmitter only), the terminal device can instead transmit three pilot signals [x,0,0], [0,y,0] and [0,0,z] in three different symbols (steps 208A, 208B and 208C in FIG. 8). Once the three symbols are received, the network node can add the received signals coherently to derive the network node DL precoder for transmitting DL traffic in step 258. For the UL, the single antenna associated with the strongest link can be used (i.e. switched UL diversity) in step 214. In the brackets in FIG. 8, the transmit precoding and the equalizer configuration to be applied at the device are indicated for each antenna element. x* is the conjugate of x.

To ensure that the terminal device has information about R and G, the terminal device may occasionally transmit raw pilots to the network node, as shown in steps 202A, 202B and 202C, and the network node determines its transmit precoder based on the received raw pilot signals. The network node may transmit communication signals to the terminal device and the terminal device may compute G based on the communication signals or may receive G from the network node in a control message.

In detail, with reference to FIG. 9, the device 30 may perform method steps 201 to 213 and the network node 20 may perform method steps 251 to 259. In particular steps 201 to 205, 210 to 213, 251 to 255, 258 and 259 shown as dashed boxes may be optional.

In step 201, the device 30 may transmit its transmitter configuration in a message to the network node 20, i.e. the device 30 may indicate that it has a lower number of transmitters than antenna elements 32. In particular the device 30 may indicate that it has only one single transmitter 38. In step 251, the network node 20 receives the transmitter configuration from the device 30 and stores this transmitter configuration for later use. The message may additionally include information concerning a receiver configuration of the device 30, for example a number of receivers which can be used by the device 30 simultaneously for receiving radio signals. The message may also include information concerning an antenna configuration of the device, for example a number of antennas which can be individually be used by the receivers and transmitters.

In step 202, the device 30 transmits raw pilot signals from each antenna element 32. As the device 30 has a lower number of transmitters than antenna elements 32, the device 30 may transmit the raw pilot signals sequentially one after the other with respect to a predefined timing scheme which may be also known to the network node 20.

The network node 20 receives the raw pilot signals in step 252. Based on the received raw pilot signals, the network node 20 determines in step 253 an equalizer configuration to be used by the network node 20 when receiving communication data from the device 30. The equalizer configuration determined in step 253 may be configured such that, when being applied to the receivers of the network node 20, the receive pattern 27 shown in FIG. 2 may be achieved. Additionally, the network node 20 may determine a Gram matrix G in step 254. The Gram matrix indicates an inner product of a channel matrix and the Hermitian conjugate of the channel matrix. The channel matrix indicates channel conditions of a wireless communication channel between the device 30 and the network node 20. The channel matrix may be determined based on the raw pilot signals received in step 252.

In step 255, the network node 20 transmits the Gram matrix G to the device of 30, which receives the Gram matrix G in step 203.

In step 204 the device 30 detects an interfering signal which may interfere the wireless communication between the network node 20 and the device 30. For example, the interfering signal may comprise radio signals from the device 40 as shown in FIGS. 1 and 2. The interfering signal may essentially interfere the communication from the network node 20 to the device 30, i.e. the downlink communication. The device 30 may determine, in step 205, a covariance matrix of interference R based on the interfering signal, for example as described above by using feICIC information provided by the network node 20 via a not shown control message or during registering.

In step 206, the device 30 determines an equalizer configuration to be used by the device 30 based on the covariance matrix of interference R. The equalizer configuration may be configured such that, when applied to the receivers 37 of the device 30, the antenna elements 32 have the receive characteristic as indicated by receive pattern 35 shown in FIG. 2. Thus, interference from device 40 may be nullified or at least attenuated.

In step 207, the device 30 determines a first transmit precoding based on the Gram matrix G and the covariance matrix of interference R. The first transmit precoding is configured such that, when applied during transmission of pilot signals from the antenna elements 32 of the device 30, it creates a transmit pattern which is reciprocal to the receive pattern 35, i.e. such that it corresponds to the receive pattern 35 which essentially nullifies or significantly attenuates the interference from the device 40. In step 208 precoded pilot signals are transmitted from each antenna element 32 of the device 30 using the first transmit precoding. As the device 30 has only a single transmitter 38, the precoded pilot signals are transmitted sequentially one after the other with respect to the predefined timing scheme which is known to the device 30 and to the network node 20.

The network noted 20 receives the subsequently transmitted precoded pilot signals in step 256. For each received precoded pilot signal a respective amplitude is determined and for each received precoded pilot signal a respective phase with respect to the predetermined timing scheme is determined at the network node 20. Thus, although the precoded pilot signals are transmitted sequentially, the network node 20 can combine the pilot signals such that it can analyze channel characteristics of the wireless communication channel between the device 30 and the network node 20 when the device 30 utilizes the equalizer configuration having the receive pattern 35. In step 257, the network node 20 determines a transmit precoding to be used by the network node for transmitting communication signals from the network node 20 to the device 30 (step 258). The transmit precoding is determined based on the amplitudes and phases of the pilot signals received in step 256. The transmit precoding may thus have the transmit pattern 28 indicated in FIG. 2.

The device 30 determines in step 209 a second transmit precoding to be used for transmitting communication signals from the device 30 to the network node 20. The second transmit precoding is based on the Gram matrix G and is independent of the covariance matrix of interference R. As a result, the second transmit precoding, when being applied during transmission of communication signals, may result in the transmit pattern 33 indicated in FIG. 2. However, as the device 30 has a single transmitter 38 only, based on the second transmit precoding one of the antenna elements may be selected for transmitting communication signals, which has a transmit characteristic which matches best to the transmit pattern 33.

In step 210 the device 30 may receive, using the equalizer configuration determined in step 206, communication data transmitted from the network node 20 in step 258. Optionally, the Gram matrix G may be re-determined or updated based on the received communication data in step 211, for example based on gain optimization.

Although not shown in FIG. 9, the device 30 may additionally transmit further pilot signals using the second transmit precoding and the network node 20 may determine and update its equalizer configuration based on these further pilot signals.

The transmission of the raw pilot signals (steps 202 and 252) may be repeated in regular terms. Likewise, the transmission of the Gram matrix G (steps 203 and 255) and the transmission of the precoded pilot signals (steps 208, 256) may be repeated in regular terms or upon request. Therefore, the methods may be restarted at steps 202 and 252, respectively. The raw pilot signals may be transmitted more frequently than the precoded pilot signals. In this case, some steps may be skipped, for example steps 206 to 208 and 256. An additional transmission of precoded pilot signals may be initiated for example when the device 20 determines in step 212 a change of the interference from the device 40. In other examples, the network node 20 may transmit in step 259 an update request to the device 30, which is received in step 213. Upon receiving the update request, the device 30 may perform at least the steps 206 to 208.

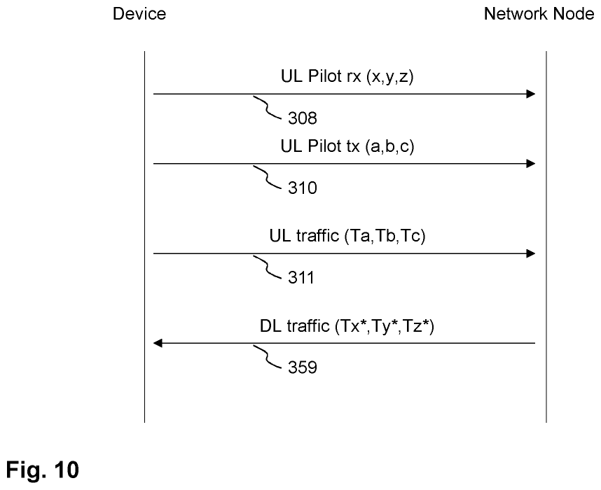

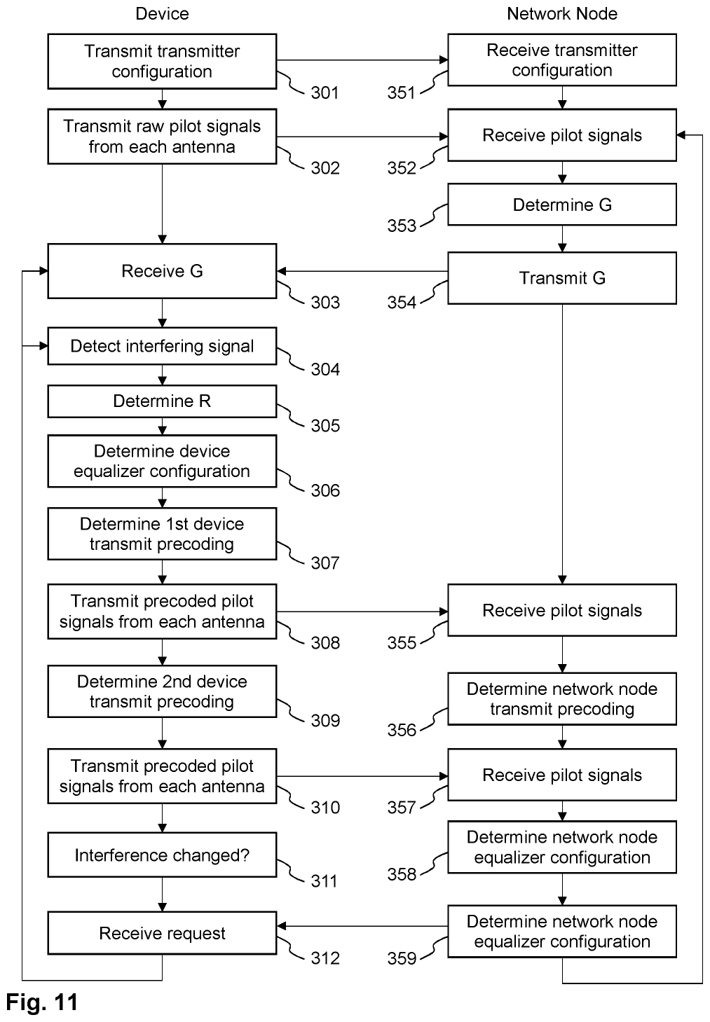

FIGS. 10 and 11 show a further method for a device and a further method for a network node. The terminal device has the same number of transmitters as the number of antenna elements, for example the terminal device may be configured as the device 30 shown in FIG. 3. FIG. 10 illustrates an overview of the principles of this method for an exemplary terminal device with three antenna elements and three transmit chains. According to these principles, two sets of precoded UL pilot signals transmitted from the terminal device to the network node are utilized. One set of precoded pilot signals (step 310) is used (according to Ŵₚ) so that the network node can derive its equalizer configuration for UL communication directly in step 311, and a separate set of precoded pilots (step 308, according to Ŵₑ) is used for the network node to derive the DL transmit precoder for DL communication in step 359. In the brackets in FIG. 10, the transmit precoding and the equalizer configuration to be applied at the device are indicated for each antenna element. x* is the conjugate of x. It is assumed that the terminal device occasionally transmits additionally raw pilots so that a Gram matrix G can be acquired. A covariance matrix of interference R may be determined as described above, for example by means of standard methods at the terminal device. Both G and R can be assumed to change slowly in this respect.

In detail, as shown in FIG. 11, the device 30 may perform method steps 301 to 310 and the network node 20 may perform method steps 351 to 358.

In step 301, the device 30 may transmit its transmitter configuration in a message to the network node 20, i.e. the device 30 may indicate that it has a same number of transmitters as antenna elements 32. In step 351, the network node 20 receives the transmitter configuration from the device 30 and considers this information in the following. The message may additionally include information concerning a receiver configuration of the device 30, for example a number of receivers which can be used by the device 30 simultaneously for receiving radio signals. The message may also include information concerning an antenna configuration of the device, for example a number of antennas which can be individually be used by the receivers and transmitters.

In step 302, the device 30 transmits raw pilot signals from each antenna element 32 in orthogonal resources.

The network node 20 receives the raw pilot signals in step 352. Based on the received raw pilot signals, the network node 20 determines in step 353 a Gram matrix G and transmits the Gram matrix G in step 354 to the device 20. The Gram matrix G indicates an inner product of a channel matrix H and the Hermitian conjugate of the channel matrix. The channel matrix H indicates channel conditions of a wireless communication channel between the device 30 and the network node 20. The channel matrix H may be determined based on the raw pilot signals received in step 352.

Although not shown in FIG. 11, the network node 20 may optionally determine an equalizer configuration to be used by the network node 20 for receiving communication signals from the device 30 based on the raw pilot signals received in step 352, for example based on the channel matrix H. This equalizer configuration may be re-determined or updated as will be explained below in step 358.

The device 30 receives the Gram matrix G in step 303.

In step 304 the device 30 detects an interfering signal which may interfere the wireless communication between the base station 20 and the device 30. For example, the interfering signal may comprise radio signals from the device 40 as shown in FIGS. 1 and 2. The interfering signal may essentially interfere the communication from the base station 20 to the device 30, i.e. the downlink communication. The device 30 may determine, in step 305, a covariance matrix of interference R based on the interfering signal, for example as described above by using feICIC information provided by the network node 20 via a not shown control message or during registering.

In step 306, the device 20 determines an equalizer configuration to be used by the device 20 based on the covariance matrix of interference R. The equalizer configuration may be configured such that, when applied to the receivers 37 of the device 20, the antenna elements 32 have a receive characteristic as indicated by receive pattern 35 shown in FIG. 2. Thus, interference from device 40 may be nullified or at least attenuated.

In step 307, the device 30 determines a first transmit precoding based on the Gram matrix G and the covariance matrix of interference R. The first transmit precoding is configured such that, when applied during transmission of pilot signals from the antenna elements 32 of the device 30, it creates a transmit pattern which is reciprocal to the received pattern 35, i.e. such that it corresponds to the receive pattern 35 which essentially nullifies or significantly attenuates the interference from the device 40. In step 308 precoded pilot signals are transmitted from each antenna element 32 of the device 30 using the first transmit precoding. The precoded pilot signals are transmitted simultaneously via the antenna elements 32 in orthogonal resources to the network node 20.

The network node 20 receives, in step 355, the precoded pilot signals transmitted by the device at 20 in step 308. For each received precoded pilot signal a respective amplitude is determined and for each received precoded pilot signal a respective phase is determined at the network node 20. Thus, the network node 20 can analyze channel characteristics of the wireless communication channel between the device 30 and the network note 20 when the device 30 utilizes the equalizer configuration having the received pattern 35. Accordingly, in step 356, the network node 20 determines a transmit precoding to be used by the network node 20 for transmitting communication signals from the network node 20 to the device 30. It is to be noticed that the transmit precoding is determined based on the amplitudes and phases of the pilot signals received in step 355. The transmit precoding may thus have the transmit pattern 28 indicated in FIG. 2.

The device 30 determines in step 309 a second transmit precoding to be used for transmitting communication signals from the device 30 to the network node 20. The second transmit precoding is based on the Gram matrix G and is independent of the covariance matrix of interference R. As a result, the second transmit precoding, when being applied during transmission of communication signals, may result in the transmit pattern 33 indicated in FIG. 2.

In step 310 the device 30 may transmit precoded pilot signals using the second transmit precoding from each antenna element 32.

The network node 20 receives, in step 357, the pilot signals transmitted by the device 30 in step 310. Based on these pilot signals, in step 358 the network node 20 determines an equalizer configuration to be used by the network node 20 when receiving communication signals from the device 30. As these pilot signals were transmitted using a transmit precoding which is independent of the covariance matrix of interference R, the equalizer configuration is aligned to the second transmit precoding (pattern 33 in FIG. 2) and may provide a receive characteristic as indicated by received pattern 27 in FIG. 2.

The transmission of the raw pilot signals (steps 302 and 352) may be repeated in regular terms. Likewise, the transmission of the Gram matrix G (steps 303 and 354) and the transmission of the precoded pilot signals (steps 308, 355) may be repeated in regular terms or upon request. Therefore, the methods may be restarted at steps 302 and 352, respectively. The raw pilot signals may be transmitted more frequently than the precoded pilot signals. In this case, some steps may be skipped, for example steps 306 to 308 and 355. An additional transmission of precoded pilot signals may be initiated for example when the device 20 determines in step 311 a change of the interference from the device 40. In other examples, the network node 20 may transmit in step 359 an update request to the device 30, which is received in step 312. Upon receiving the update request, the device 30 may perform at least the steps 306 to 308.

1. A method for operating a device of a wireless multiple-input and multiple-output (MIMO) system providing a wireless communication between the device and a network node of the MIMO system, the method comprising:
transmitting from each individual antenna element of a plurality of antenna elements of the device, a respective raw pilot signal in orthogonal resources to the network node;
transmitting a message indicative of a covariance matrix of interference to the network node, wherein the covariance matrix of interference is based on an interfering signal interfering the wireless communication;
determining an equalizer configuration to be used for receiving communication signals from the network node, wherein the equalizer configuration is based on the covariance matrix of interference,
receiving from the network node, a message indicative of a transmit precoding information, the transmit precoding information being determined by the network node based on the raw pilot signals;
determining a transmit precoding to be used by the device for transmitting communication signals to the network node, wherein the transmit precoding is based on the transmit precoding information.

2. The method of claim 1, wherein the method further comprises:
detecting the interfering signal interfering the wireless communication;
determining the covariance matrix of interference based on the interfering signal.

3. The method of claim 2, wherein the transmit precoding information is indicative of a Gram matrix, the Gram matrix being determined at the network node based on the raw pilot signals received at the network node, the Gram matrix being indicative of an inner product of a channel matrix indicative of channel conditions of a wireless communication channel between the device and the network node and the Hermitian conjugate of the channel matrix;
determining the transmit precoding to be used by the device based on the Gram matrix.

4. The method of claim 1, wherein a time interval between a transmission of the raw pilots from each individual antenna element and a further transmission of raw pilots from each individual antenna element is smaller than a time interval between a transmission of the message indicative of the covariance matrix of interference and a further transmission of a further message indicative of a further covariance matrix of interference.

5. The method of claim 1, further comprising:
transmitting a further message indicative of a further covariance matrix of interference upon detecting a change in the interfering signal.

6. The method of claim 1, further comprising:
receiving, from the network node, a request for transmitting a further covariance matrix of interference, and upon receiving the request:
detecting the interfering signal interfering the wireless communication;
determining a further covariance matrix of interference based on the interfering signal;
transmitting a further message indicative of the further covariance matrix of interference.

7. The method of claim 1, further comprising:
transmitting a message indicative of a transmitter configuration the device.

8. The method of claim 1, wherein the raw pilot signals are transmitted simultaneously via the plurality of antenna elements.

9. The method of claim 8, wherein the device comprises for each antenna element of the plurality of antenna elements a respective radio transmitter.

10. The method of claim 1, wherein the raw pilot signals are transmitted sequentially one after the other via the plurality of antenna elements.

11. The method of claim 10, wherein the device comprises a lower number of radio transmitters than the number of antenna elements of the plurality of antenna elements, wherein the device comprises a switching element configured to selectively couple at least one of the radio transmitters with either a first antenna element of the plurality of antenna elements or a second antenna element of the plurality of antenna elements.

12-13. (canceled)

14. A method for operating a device of a wireless multiple-input and multiple-output (MIMO) system providing a wireless communication between the device and a network node of the MIMO system, the method comprising:
determining an equalizer configuration to be used for receiving communication signals from the network node based on a covariance matrix of interference, wherein the covariance matrix of interference is based on an interfering signal interfering the wireless communication;
determining a first transmit precoding based on a Gram matrix and the covariance matrix of interference, the Gram matrix being indicative of an inner product of a channel matrix indicative of channel conditions of a wireless communication channel between the device and the network node and the Hermitian conjugate of the channel matrix;
transmitting, from each individual antenna element of a plurality of antenna elements of the device, a respective precoded pilot signal using the first transmit precoding, wherein the precoded pilot signals are transmitted sequentially one after the other via the plurality of antenna elements;
determining a second transmit precoding for transmitting communication signals to the network node, wherein the second transmit precoding is based on the Gram matrix and independent of the covariance matrix of interference.

15. The method of claim 14, further comprising:
detecting the interfering signal interfering the wireless communication; and
determining the covariance matrix of interference based on the interfering signal.

16. The method of claim 14, wherein the equalizer configuration is based additionally on the first transmit precoding.

17. The method of claim 14, further comprising:
determining the second transmit precoding based on a transmitter configuration of the device.

18. The method of claim 14, wherein the device comprises a lower number of radio transmitters than the number of antenna elements of the plurality of antenna elements, wherein the device comprises a switching element configured to selectively couple at least one of the radio transmitters with either a first antenna element of the plurality of antenna elements or a second antenna element of the plurality of antenna elements.

19. The method of claim 14, further comprising:
transmitting, from each individual antenna element of a plurality of antenna elements of the device, a raw pilot signal, wherein the raw pilot signals are transmitted individually one after the other via the plurality of antenna elements,
receiving the Gram matrix from the network node.

20. The method of claim 14, further comprising:
receiving, at the plurality of antenna elements of the device, a communication signal from the network node,
determining the Gram matrix based on the communication signal received from the network node at the plurality of antenna elements.

21-22. (canceled)

23. A method for operating a network node of a wireless multiple-input and multiple-output (MIMO) system providing a wireless communication between a device of the MIMO system and the network node, the method comprising:
receiving, at a plurality of antennas of the network node, a plurality of raw pilot signals in orthogonal resources from the device;
receiving a message indicative of a covariance matrix of interference from the device, the covariance matrix of interference being determined by the device based on detecting an interfering signal interfering the wireless communication;
determining a transmit precoding to be used by the network node for transmitting communication signals to the device, wherein the transmit precoding is based on the plurality of raw pilot signals and the covariance matrix of interference,
transmitting a message indicative of a transmit precoding information to the device, wherein the transmit precoding information is indicative of a transmit precoding to be used by the device for transmitting communication signals to the network node, wherein the transmit precoding information is based on the plurality of raw pilot signals;
determining an equalizer configuration to be used by the network node for receiving communication signals from the device, wherein the equalizer configuration is based on the plurality of raw pilot signals.

24. The method of claim 23, wherein the method further comprises:
determining a channel matrix indicative of channel conditions of a wireless communication channel between the device and the network node based on the plurality of raw pilot signals;
determining the transmit precoding information based on the channel matrix.

25-37. (canceled)
